(19) United States
(12) Patent Application Publication
(10) Pub. No.: US 2024/0336446 A1
(43) Pub. Date: Oct. 10, 2024

(54) TRAY PROCESSING UNITS FOR CARBON CAPTURE AND REMOVAL SYSTEMS, AND METHODS OF OPERATING THE SAME

(71) Applicant: Heirloom Carbon Technologies, Inc., Brisbane, CA (US)

(72) Inventors: Rocky MAI, San Mateo, CA (US); Hunter GARNIER, San Bruno, CA (US); Isabel GUEBLE, Sunnyvale, CA (US); Charlie KARR, San Francisco, CA (US); Kristen PEDERSEN, San Francisco, CA (US); Noah PAUL-GIN, San Francisco, CA (US); Ruofei LIU, San Jose, CA (US); Maryam NASSAR, Sacramento, CA (US); Shazib ELAHI, Fremont, CA (US); David DRENNAN, Springfield, NH (US); Tejas MANEM, San Bruno, CA (US); Hugo SANCHEZ, San Bruno, CA (US); Jennifer MILLS, San Leandro, CA (US); Robert DUNCAN, San Francisco, CA (US); Margaret KANE, Mountain View, CA (US); Andy DUBEL, Moss Beach, CA (US); Noah MCQUEEN, San Francisco, CA (US)

(21) Appl. No.: 18/626,398

(22) Filed: Apr. 4, 2024

Related U.S. Application Data
(60) Provisional application No. 63/494,285, filed on Apr. 5, 2023.

(51) Int. Cl. B65G 65/02; B01D 53/62; B01D 53/81; B01D 53/96; B65G 69/18

(52) U.S. Cl. CPC B65G 65/02; B01D 53/62; B01D 53/81; B01D 53/96; B65G 69/18; B01D 2257/504

(57) ABSTRACT

Embodiments described herein relate to tray processing units for processing CO₂ capture media. In some aspects a tray processing unit can include a loading dock configured to receive a caddy including trays disposed thereon, a collection station configured to receive trays from the loading dock and collect a carbonated medium from the trays, a filling station configured to transfer a carbonation medium to the trays, a first tray mover configured to transport the trays from the caddy at the loading dock to the collection station, an unloading dock configured to support the caddy while loading the caddy with trays, a second tray mover configured to transport trays from the collection station to the filling station, and a third tray mover configured to transport trays from the filling station to the caddy supported by the unloading dock.

### RELATED APPLICATIONS

This application claims priority and the benefit of U.S. Provisional Application No. 63/494,285, filed Apr. 5, 2023 and titled, “Central Tray Processing Units for Carbon Capture and Removal Systems, and Methods of Operating the Same” the disclosure of which is hereby incorporated by reference in its entirety.

### TECHNICAL FIELD

Embodiments described herein relate to control systems and methods for processing CO₂ capture media.

### BACKGROUND

The atmospheric concentration of CO₂ has reached 420 parts per million by volume (ppm), an increase of almost 20 ppm in the last 10 years. As current emission levels exceed 35 GtCO₂/year, a diverse portfolio of CO₂ mitigation technologies must be developed and strategically deployed to avoid a 2° C. increase in Earth's average surface temperature by 2100. Due to global reliance on fossil fuels, this portfolio must include technologies that can remove current and future CO₂ emissions from the atmosphere, some of which include the acceleration of natural processes such as the CO₂ uptake of oceans and the terrestrial biosphere (soils, forests, minerals), bioenergy with carbon capture and storage (BECCS), and synthetic approaches using chemicals also known as direct air capture with storage (DACS) technologies. State of the art DACS systems rely on media to capture CO₂ from the atmosphere. Once the media has been exhausted, in some systems it must be transported for further processing and recycling. The turnover of the carbon capture medium can be a rate limiting step in the overall carbon capture process. By minimizing the turnover and processing time of the carbon capture medium, the efficiency of a carbon capture system can be improved.

### SUMMARY

Embodiments described herein relate to tray processing units for processing CO₂ capture media. In some aspects a tray processing unit can include a loading dock configured to receive a caddy including trays disposed thereon, a collection station configured to receive trays from the loading dock and collect a carbonated medium from the trays, a filling station configured to transfer a carbonation medium to the trays, a first tray mover configured to transport the trays from the caddy at the loading dock to the collection station, an unloading dock configured to support the caddy while loading the caddy with trays, a second tray mover configured to transport trays from the collection station to the filling station, and a third tray mover configured to transport trays from the filling station to the caddy supported by the unloading dock. In some embodiments, the tray processing unit can further include an unloader configured to transport trays from the loading dock to the collection station, the unloader configured to move vertically to select a vertical placement position of the trays in the caddy. In some embodiments, the unloader and the first tray mover can be part of the same structure and the structure can include a vertical mover configured to collect trays at different positions in the caddy supported by the loading dock. In some embodiments, the tray processing unit can further include a loader that transport trays from the second tray mover to the caddy at the unloading dock.

### BRIEF DESCRIPTION OF THE DRAWINGS

FIG. 1 is a block diagram of a tray processing unit, according to an embodiment.

FIG. 2 is a block diagram of a carbon capture system, according to an embodiment.

FIGS. 3A-3B are schematic diagrams of a tray processing unit, according to an embodiment.

FIG. 4 illustrates a tray processing scheme in a tray processing unit, according to an embodiment.

FIG. 5 is an overhead diagram of a tray processing unit in relation to a contactor system, according to an embodiment.

FIG. 6 shows the transportation of a caddy to a carbonation contactor, according to an embodiment.

FIGS. 7A-7B show a caddy with trays thereon, according to an embodiment.

FIG. 8 shows a collection station, according to an embodiment.

FIG. 9 shows a filling station, according to an embodiment.

FIG. 10 shows a spraying apparatus, according to an embodiment.

FIG. 11 shows a carbonation medium dispenser, according to an embodiment.

FIG. 12 shows a tray mover, according to an embodiment.

FIG. 13 shows a tray movement scheme, according to an embodiment.

FIG. 14 shows a tray distributor, according to an embodiment.

FIGS. 15A-15B show a tray stacking scheme, according to an embodiment.

FIGS. 16A-16B show an engagement between a vehicle, a caddy, and a docking station, according to an embodiment.

FIG. 17 shows an overhead view of a carbonation medium delivery scheme, according to an embodiment.

FIG. 18 shows an overhead view of a carbonation medium delivery scheme, according to an embodiment.

FIG. 19 shows a flow diagram of a method of processing trays in a carbonation system, according to an embodiment.

### DETAILED DESCRIPTION

Embodiments described herein relate to tray processing unit (TPU) for incorporation into carbon capture systems. TPU systems provide a centralized location for collection of material to undergo regeneration into a carbonation medium. Fresh or regenerated carbonation medium (i.e., material that has been processed in a system that removes CO₂ from CaCO₃) is distributed onto trays. The carbonation medium can then be processed via the addition of water. The carbon medium is then sent to carbonation plots via a distribution vehicle. Once the carbonation medium has taken up CO₂ from ambient air, the trays including the now carbonated medium can be collected by a collection vehicle and sent back to the TPU. In some embodiments, the trays can be selected and placed into the vehicle to achieve a desired condition (e.g., carbonation extent). In some embodiments, the collection vehicle can be the same vehicle as the distribution vehicle. The carbonated medium can then be sent back to a regeneration system, where the carbonated medium is transformed back to a carbonation medium. In some embodiments, the regeneration system can include a calciner, a dissolution/precipitation-based system, and/or an electrochemical system for conversion of the carbonated medium to the carbonation medium.

Embodiments described herein can reduce capital expenses and operating expenses by centralizing two important components of the carbon capture process: (1) filling (i.e., placing carbonation medium onto a tray) and (2) collection (i.e., removing carbonated material from a tray). Embodiments described herein can resolve throughput mismatches in carbon capture and carbon regeneration equipment. Previously, tray distributors (i.e., components that deliver and collect trays of material in a contactor or carbonation plot) and trays were bottlenecks for throughput. The trays are bottlenecks due to the carbonation time of the material. Filling and collection stations are often under-utilized.

Embodiments described herein work to maintain process-sensitive equipment. Filling and collection processes are sensitive to parameter changes. By reducing the number of components involved in the process, there is less need for equipment maintenance and labor costs associated with operating the process are also reduced.

In some embodiments, trays and contactor units described herein can be the same or substantially similar to those described in U.S. Provisional Patent Application No. 63/358,602 (“the '602 application”), filed Jul. 6, 2022, and titled, “Direct Air Capture Contactor for Carbon Uptake, and Methods of Operating the Same,” the disclosure of which is hereby incorporated by reference in its entirety. In some embodiments, calciners or other processing equipment described herein can be the same or substantially similar to equipment described in U.S. patent application Ser. No. 18/067,896 (“the '896 application), filed Dec. 19, 2022 and titled “Systems and Methods of Carbon Capture from Cement Production Process,” the disclosure of which is hereby incorporated by reference in its entirety.

In some embodiments, the carbonation medium and/or the contactors described herein can have any of the properties described in International Patent Publication No. 2020/263910 (“the '910 publication”), filed Jun. 24, 2020, and titled, “Systems and Methods for Enhanced Weathering and Calcining for CO₂ Removal from Air,” the disclosure of which is hereby incorporated by reference in its entirety. In some embodiments, the carbonation medium and/or the contactors described herein can have any of the properties described in International Patent Publication No. 2022/187336 (“the '336 publication”), filed Mar. 2, 2022, and titled, “Systems and Methods for Enhanced Weathering and Calcining for CO₂ Removal from Air,” the disclosure of which is hereby incorporated by reference in its entirety. Benefits of interactions between water and carbonation medium are described in greater detail in the '910 publication and the '336 publication.

As used herein, “carbonation plot,” includes single contiguous plots, as well as semi- or non-contiguous plots that are then grouped or processed together to effectively act as a single plot. In some embodiments, carbonation plots include a composition that sequesters a target compound (e.g., CO₂). In some embodiments, carbonation plots are positioned and configured to expose the composition to ambient conditions.

As used herein, “stream” can refer to stream that includes solid, liquid, and/or gas. For example, a stream can include a solid in granular form conveyed on a conveyor device. A stream can also include a liquid and/or gas flowing through a pipe. A stream can include a solution.

As used herein, “carbonation medium” refers to a medium that can take on carbon dioxide when exposed to ambient air. This can include but is not limited to calcium oxide (CaO), calcium hydroxide (Ca(OH)₂), magnesium oxide (MgO), magnesium hydroxide (MgOH), sodium oxide (Na₂O), sodium hydroxide (NaOH), and/or dolomitic lime (calcium-magnesium oxide or hydroxide). Carbonation medium can originate from a natural source (e.g., limestone). Carbonation medium can also be regenerated or recycled (i.e., a regenerated carbonated medium from a calciner).

As used herein, “carbonated medium” refers to a carbonation medium that has taken up carbon dioxide from ambient air. This can include but is not limited to calcium carbonate (CaCO₃), magnesium carbonate (MgCO₃), sodium carbonate (Na₂CO₃), sodium bicarbonate (NaHCO₃), mixed calcium-magnesium carbonate phases ((Ca,Mg)CO₃). Carbonated medium can be converted back to a carbonation medium (e.g., via the use of a calciner, a dissolution/precipitation-based system, and/or an electrochemical system).

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of contactors, the set of contactors can be considered as one contactor with multiple portions, or the set of contactors can be considered as multiple, distinct contactors. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, a “caddy” can refer to a movable storage container. In some embodiments, movement of a caddy can be automated. In some embodiments, movement of a caddy can be controlled by an algorithm. In some embodiments, movement of a caddy can be controlled by user inputs. In some embodiments, movement of a caddy can be via physical pushing or pulling by a user. In some embodiments, a caddy can move along the ground via wheels. In some embodiments, a caddy can slide along the ground. In some embodiments, a caddy can include a mobile storage container that holds a multitude of carbonation medium and/or carbonated medium in contact with air.

As used herein, the term “about” and “approximately” generally means plus or minus 10% of the value stated, e.g., about 250 μm would include 225 μm to 275 μm, about 1,000 μm would include 900 μm to 1,100 μm.

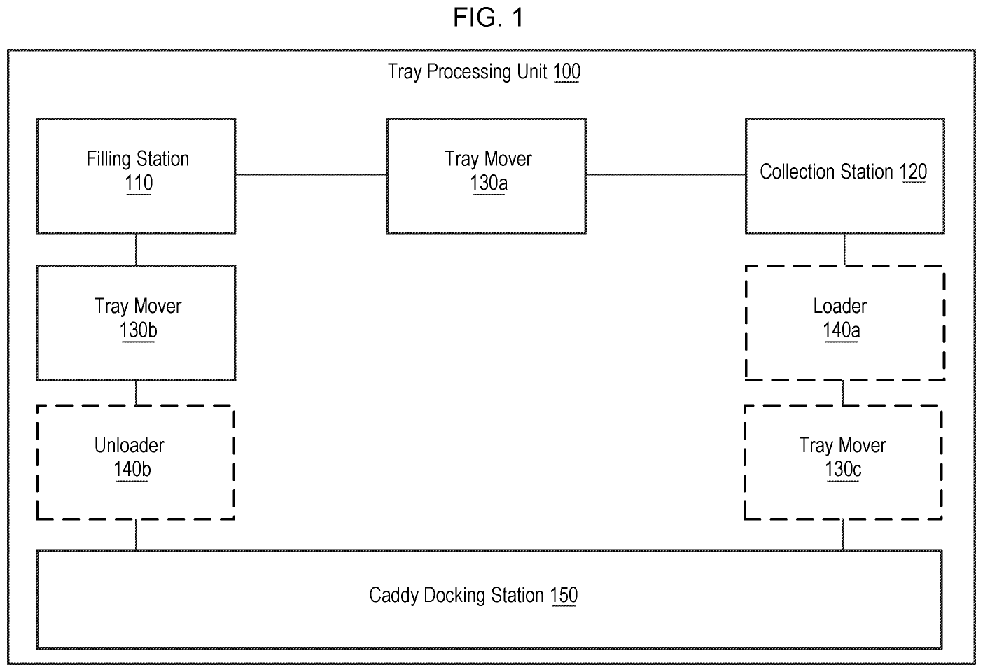

FIG. 1 is a block diagram of a tray processing unit (TPU) 100, according to an embodiment. As shown, the TPU 100 includes a filling station 110, a collection station 120, tray movers 130a, 130b, optional loader 140a, unloader 140b, and a caddy docking station 150. In some embodiments, the TPU 100 can include a tray mover 130c that transports trays from the caddy docking station 150 to the collection station 120 and/or the loader 140a. The tray movers 130a, 130b, 130c are collectively referred to herein as tray movers 130. In some embodiments, the TPU 100 can include a conveyor (not shown) that transports caddies between a loading dock of the caddy docking station 150 and an unloading dock of the caddy docking station 150.

Carbonation medium is placed into trays at the filling station 110. In some embodiments, the filling station 110 can include an assembly line of trays that are filled with carbonation medium. In some embodiments, the filling of the trays can be via a dispensation device. In some embodiments, the carbonation medium can be stored in one or more silos and dispensed from the silos to the trays via the dispensation device. In some embodiments, the carbonation medium can include CaO, MgO, Na₂O, Ca(OH)₂, Mg(OH)₂, NaOH, dolomitic lime, or any combination thereof. In some embodiments, the trays can be dual-sided and/or include multiple compartments, such that multiple dispensations can be fed to a single tray.

In some embodiments, at least about 0.5 kg, at least about 1 kg, at least about 2 kg, at least about 3 kg, at least about 4 kg, at least about 5 kg, at least about 6 kg, at least about 7 kg, at least about 8 kg, at least about 9 kg, at least about 10 kg, at least about 11 kg, at least about 12 kg, at least about 13 kg, at least about 14 kg, at least about 15 kg, at least about 16 kg, at least about 17 kg, at least about 18 kg, or at least about 19 kg of carbonation medium can be dispensed into each tray. In some embodiments, no more than about 20 kg, no more than about 19 kg, no more than about 18 kg, no more than about 17 kg, no more than about 16 kg, no more than about 15 kg, no more than about 14 kg, no more than about 13 kg, no more than about 12 kg, no more than about 11 kg, no more than about 10 kg, no more than about 9 kg, no more than about 8 kg, no more than about 7 kg, no more than about 6 kg, no more than about 5 kg, no more than about 4 kg, no more than about 3 kg, no more than about 2 kg, or no more than about 1 kg of carbonation medium can be dispensed into each tray. Combinations of the above-referenced amounts of carbonation medium are also possible (e.g., at least about 0.5 kg and no more than about 10 kg or at least about 1 kg and no more than about 5 kg), inclusive of all values and ranges therebetween. In some embodiments, about 0.5 kg, about 1 kg, about 2 kg, about 3 kg, about 4 kg, about 5 kg, about 6 kg, about 7 kg, about 8 kg, about 9 kg, about 10 kg, about 11 kg, about 12 kg, about 13 kg, about 14 kg, about 15 kg, about 16 kg, about 17 kg, about 18 kg, about 19 kg, or about 20 kg of carbonation medium can be dispensed into each tray.

In some embodiments, the carbonation medium can be dispensed into each tray at a thickness of at least about 0.5 mm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, at least about 9 cm. In some embodiments, the carbonation medium can be dispensed into each tray at a thickness of no more than about 10 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, or no more than about 1 mm. Combinations of the above-referenced thicknesses of the carbonation medium are also possible (e.g., at least about 0.5 mm and no more than about 10 cm or at least about 5 mm and no more than about 1 cm), inclusive of all values and ranges therebetween. In some embodiments, the carbonation medium can be dispensed into each tray at a thickness of about 0.5 mm, about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, or about 10 cm.

In some embodiments, the filling station 110 can include a water addition station (not shown). At the water addition station, water can be added to the carbonation medium. The water content in the carbonation medium can improve CO₂ uptake, as described in the '336 publication. In some embodiments, water can adhere the carbonation medium together to create a permeable crust. In some embodiments, water can be added to the carbonation medium at the filling station 110. In some embodiments, water can be added to the carbonation medium after the carbonation medium has left the filling station 110. The adhering can aid in keeping the carbonation medium on the trays and setting the carbonation medium in place. In some embodiments, the filling station 110 can include an agitator. The agitator can be located inside the filling station 110 and can aid in keeping the carbonation medium fluid as it is dispensed (e.g., from a hopper). In other words, the agitator prevents clumping of carbonation medium inside the filling station 110. In some embodiments, the filling station 110 can include humidity and/or temperature monitoring and control instruments. In some embodiments, the filling station 110 can include cleaning and/or drying instruments to clean the trays before filling.

Carbonated medium is collected at the collection station 120. In some embodiments, the collection station 120 can include a trough to catch the carbonated medium. In some embodiments, the collection station 120 can include a rotating arm to grip and turn over the trays to empty the trays into the trough. In some embodiments, the collection station 120 can include a hopper for collection of the carbonated medium. In some embodiments, the hopper can be cylindrical, pyramidal, wedge-shaped, or chisel-shaped. In some embodiments, the collection station 120 can include a vibration motor or agitator to vibrate the trays and aid the carbonation medium in falling from the trays. In some embodiments, the carbonated medium can be transferred from the collection station 120 to a calciner. In some embodiments, the carbonated medium can be transferred from the collection station 120 to a storage area via an conveyor. In some embodiments, the conveyor can include an auger. In some embodiments, the storage area can include a silo. In some embodiments, the carbonated medium can be transferred from the collection station 120 to the storage area pneumatically. In some embodiments, the collection station 120 can include a tray enclosure that manipulates the trays. In some embodiments, manipulating the trays can include touching the trays (e.g., via the rotating arm). In some embodiments, the manipulation can exclude direct touching of the trays. In some embodiments, the manipulation can include rotating the trays, vibrating the trays, applying a vacuum to the trays, stirring the contents of the trays, and/or applying ultrasonic waves to the trays.

The tray movers 130 transfer trays between sections of the TPU 100. In some embodiments, the tray movers 130 can include conveyors. In some embodiments, the tray movers 130 can include screw drives. In some embodiments, the tray movers 130 can include actuated end effector pins to move the trays via grommets. In some embodiments, the tray movers 130 can enable two-direction translation. In some embodiments, the tray movers 130 can enable tray velocity profile control. In some embodiments, the tray movers 130 can include belt conveyors. In some embodiments, the tray movers 130 can include a belt drive. In some embodiments, the tray movers 130 can include chain conveyors. In some embodiments, the tray movers 130 can include aero-mechanical conveyors. In some embodiments, the tray movers 130 can include bucket conveyors. In some embodiments, the tray movers 130 can include distributors and effectors.

In some embodiments, the distributors and effectors can be positioned beneath conveyors. In some embodiments, the distributors and effectors can be positioned at either end of the conveyors for hand-off. In some embodiments, the conveyor can include a 2-direction roller belt. In some embodiments, the conveyor can include lead-in movement paths (analogous to airport luggage conveyors). In some embodiments, the conveyor can include a roller conveyor with retractable index pins. The pins can engage with the trays and secure the trays to the conveyor. In some embodiments, the conveyor can include various end effector configurations. In some embodiments, the conveyor can include pegs that automatically engage, move, and disengage the trays. In some embodiments, the conveyor can include end effectors on an X-Y gantry. In some embodiments, the conveyor can include end effectors on a rack, driven by a pinion.

In some embodiments, the tray movers 130 can be fastened to walls via angle brackets. In some embodiments, the tray movers 130 can include end stops to limit tray travel. In some embodiments, the tray movers 130 include powered rail cars, such that a tray rides on a moving carriage with rails. In some embodiments, the tray movers 130 can include a conveyor and a distributor actuator. In some embodiments, the tray movers 130 can include a pinch roller on the tray edge. In some embodiments, the tray movers 130 can include holes along the edge of the tray engaged by sprockets. In some embodiments, the tray movers 130 can include removable handles added to the tray during conveyance. In some embodiments, the tray movers 130 can include a hitch feed with end effectors to move two or more trays at once. In some embodiments, the tray movers 130 can include an expanding pin to reduce clearance with the grommet. In some embodiments, the tray movers 130 can include a fan with small holes (analogous to an air hockey table) with a downward bearing to facilitate smooth movement of the trays along the tray movers 130. In some embodiments, the tray movers 130 can include a retractable guide rail for 2-direction travel. In some embodiments, the tray movers 130 can include an automated guide vehicle (AGV) to move the trays. In some embodiments, the tray movers 130 can include an arm to push the trays. In some embodiments, the tray movers 130 can include a carriage driven by a cable cylinder. In some embodiments, the tray movers 130 can include a mecanum wheel under the tray. In some embodiments, the tray movers 130 can include a shuttling system that conveys multiple trays at a time, each in various phases of the transport process.

The loader 140a is optional and can move the trays to a vertical position (e.g., for placement in a caddy). In some embodiments, the loader 140a can include one or more stackers and the unloader 140b can include one or more destackers. In some embodiments, the stackers can include vertically-mobile instruments that elevate trays upward and place the trays in a desired vertical position (e.g., in a caddy). The placement of the trays in the desired vertical position can include horizontal movement of the trays (e.g., via wheels, actuators, conveyors) onto the caddies. In some embodiments, the destackers can include vertically-mobile instruments that retrieve trays from their vertical position (e.g., via horizontal motion) and place the trays in tray movers 130 and/or the collection station 120. In some embodiments, the loader 140a and/or the unloader 140b can include any of the properties of the distributors described in the '602 application. In some embodiments, the loader 140a and/or the unloader 140b can include a stationary caddy and use common distributor mechanisms for horizontal motion. In some embodiments, the loader 140a and/or the unloader 140b can include a belt drive and/or a screw drive. In some embodiments, the loader 140a and/or the unloader 140b can include a z-motion platform. Actuators can use a lead screw drive (e.g., a direct drive or scissor lift). In some embodiments, caddies can be moved up and down via a pulley system and/or a hydraulic/pneumatic bed. In some embodiments, the loader 140a and/or the unloader 140b can include a stationary caddy and a moving conveyance/elevation mechanism. In some embodiments, the loader 140a and/or the unloader 140b can include a scissor lift and a conveyor. In some embodiments, the loader 140a and/or the unloader 140b can include a mini distributor. In some embodiments, the mini distributor can have any of the properties of the distributors described in the '602 application. In some embodiments, the mini distributor can distribute trays without additional functionality. In other words, functional components such as sprayers and/or mass measurement devices are optional in the mini distributor and can be absent from the mini distributor. In some embodiments, the loader 140a and/or the unloader 140b can include an AGV to raise and lower caddies. In some embodiments, the loader 140a and/or the unloader 140b can include hinge tilts to move the trays to different tray levels.

In some embodiments, the loader 140a can include both a vertical and a horizontal movement mechanism. In some embodiments, the vertical movement mechanism and the horizontal movement mechanism can be part of the same apparatus. In other words, the vertical movement mechanism (e.g., elevator or lift) can be physically coupled to the horizontal movement mechanism (e.g., conveyor, stacker). In some embodiments, the vertical and horizontal movement mechanism can be de-coupled from each other.

In some embodiments, the unloader 140b can include both a vertical and a horizontal movement mechanism. In some embodiments, the vertical movement mechanism and the horizontal movement mechanism can be part of the same apparatus. In other words, the vertical movement mechanism (e.g., elevator or lift) can be physically coupled to the horizontal movement mechanism (e.g., conveyor, destacker). In some embodiments, the vertical and horizontal movement mechanism can be de-coupled from each other.

In some embodiments, z-motion platform actuators in the loader 140a and/or the unloader 140b can include a screw actuator, pulleys, cables, a scissor lift, a pneumatic cylinder, and/or a belt drive. In some embodiments, the loader 140a and/or the unloader 140b can include end effectors for horizontal movement and a single actuator for both end effectors. In some embodiments, the loader 140a and/or the unloader 140b can grab and pull trays via a lip and/or edge. In some embodiments, the trays can be flat (i.e., without a lip or edge). In embodiments with flat trays, the loader 140a and/or the unloader 140b can grab the trays via grabbing arms and/or holes on the edges of the trays. In some embodiments, the loader 140a and/or the unloader 140b can reach behind the tray lip to drag the tray. In some embodiments, the loader 140a and/or the unloader 140b can include a short stroke end effector and conveyor. In some embodiments, the loader 140a and/or the unloader 140b can include a belt drive. In some embodiments, any of the loader 140a, the unloader 140b and/or the tray movers 130 can be part of the same structure. In some embodiments, the structure can include a vertical mover that collects trays at different portions in either of the caddies in the TPU 100 (e.g., a caddy supported by a loading station and/or an unloading station of the caddy docking station 150).

In some embodiments, the loader 140a and/or the unloader 140b can include pegs on conveyors that automatically engage, move, and disengage trays. In some embodiments, the loader 140a and/or the unloader 140b can include an elevator bed in a box with a counterweight. In some embodiments, the loader 140a and/or the unloader 140b can include a stepper motor. The loader 140a and/or the unloader 140b can include an air actuator. In some embodiments, the loader 140a and/or the unloader 140b can include a tray sensor with a z stage to determine the tray level. In some embodiments, the loader 140a and/or the unloader 140b can include mechanisms within the caddy, such as a movable shelf or a tray carousel.

The docking station 150 provides an area for delivery and retrieval of caddies with trays. In some embodiments, the docking station 150 can include a loading station and an unloading station. In some embodiments, caddies can be aligned in the docking station 150 via retractable tapered pins. In some embodiments, the caddies can be aligned via kinematic coupling using a magnet or pneumatic actuators. In some embodiments, caddies can be conveyed through the caddy docking station 150 via a roller conveyor or rollers on wrap-around chains pushing on carry wheels. In some embodiments, the roller conveyors can include retractable alignment pins between rollers. In some embodiments, the docking station 150 can include vision cameras for detection of a tag on a side of a caddy.

In some embodiments, the docking station 150 can include locating features. In some embodiments, the locating features can include cone-shaped pins, diamond shaped pins, holes, and/or slots. In some embodiments, the docking station 150 can include a vertical lift mechanism to dock and undock caddies. In some embodiments, the docking station 150 can include a belt drive to move the caddies on and off the AGV. In some embodiments, the caddy can have wheels that ride on rails. In some embodiments, the caddy can include a wheel that moves through tracks in the docking station 150 (analogous to a cabinet drawer rail/wheel combination). In some embodiments, the docking station can include rollers on chains that push wheels of the caddies (analogous to a car wash).

In some embodiments, the docking station 150 can include an overhead conveyor that moves the caddy along. In some embodiments, the docking station 150 can include pegs on a belt or chain conveyor. In some embodiments, the docking station 150 can include a carriage with index pins. In some embodiments, the carriage can include a reciprocating X-Z stage carriage. In some embodiments, the carriage can include a lead screw carriage. In some embodiments, the carriage can include a linear motor carriage. In some embodiments, the docking station 150 can include a lift-up conveyor at its center. This can work with a forklift AGV. In some embodiments, the docking station 150 can include a hitch feed, such that caddies can latch onto each other. In some embodiments, the docking station 150 can include an electromagnet contactor for alignment. In some embodiments, the caddy can be fed to the docking station 150 via an automatic feed system using springs. In some embodiments, the docking station 150 can include side rollers and/or brushes to keep caddies aligned during motion. In some embodiments, the docking station 150 can include an omni-directional wheels platform. In some embodiments, the docking station 150 can include a tool changer magnetic coupler. In some embodiments, the docking station 150 can include a pneumatic powered kinematic coupler.

In some embodiments, the TPU 100 can process at least about 10 kg/hr, at least about 20 kg/hr, at least about 30 kg/hr, at least about 40 kg/hr, at least about 50 kg/hr, at least about 60 kg/hr, at least about 70 kg/hr, at least about 80 kg/hr, at least about 90 kg/hr, at least about 100 kg/hr, at least about 200 kg/hr, at least about 300 kg/hr, at least about 400 kg/hr, at least about 500 kg/hr, at least about 600 kg/hr, at least about 700 kg/hr, at least about 800 kg/hr, at least about 900 kg/hr, at least about 1 tonne (metric ton)/hr, at least about 2 tonnes/hr, at least about 3 tonnes/hr, at least about 4 tonnes/hr, at least about 5 tonnes/hr, at least about 6 tonnes/hr, at least about 7 tonnes/hr, at least about 8 tonnes/hr, at least about 9 tonnes/hr, at least about 10 tonnes/hr, at least about 20 tonnes/hr, at least about 30 tonnes/hr, at least about 40 tonnes/hr, at least about 50 tonnes/hr, at least about 60 tonnes/hr, at least about 70 tonnes/hr, at least about 80 tonnes/hr, at least about 90 tonnes/hr, at least about 100 tonnes/hr, at least about 200 tonnes/hr, at least about 300 tonnes/hr, at least about 400 tonnes/hr, at least about 500 tonnes/hr, at least about 600 tonnes/hr, at least about 700 tonnes/hr, at least about 800 tonnes/hr, at least about 900 tonnes/hr, at least about 1,000 tonnes/hr, at least about 2,000 tonnes/hr, at least about 3,000 tonnes/hr, at least about 4,000 tonnes/hr, at least at least about 5,000 tonnes/hr, at least at least about 6,000 tonnes/hr, at least at least about 7,000 tonnes/hr, at least at least about 8,000 tonnes/hr, or at least about 9,000 tonnes/hr of carbonated medium. In some embodiments, the TPU 100 can process no more than about 10,000 tonnes/hr, no more than about 9,000 tonnes/hr, no more than about 8,000 tonnes/hr, no more than about 7,000 tonnes/hr, no more than about 6,000 tonnes/hr, no more than about 5,000 tonnes/hr, no more than about 4,000 tonnes/hr, no more than about 3,000 tonnes/hr, no more than about 2,000 tonnes/hr, no more than about 1,000 tonnes/hr, no more than about 900 tonnes/hr, no more than about 800 tonnes/hr, no more than about 700 tonnes/hr, no more than about 600 tonnes/hr, no more than about 500 tonnes/hr, no more than about 400 tonnes/hr, no more than about 300 tonnes/hr, no more than about 200 tonnes/hr, no more than about 100 tonnes/hr, no more than about 90 tonnes/hr, no more than about 80 tonnes/hr, no more than about 70 tonnes/hr, no more than about 60 tonnes/hr, no more than about 50 tonnes/hr, no more than about 40 tonnes/hr, no more than about 30 tonnes/hr, no more than about 20 tonnes/hr, no more than about 10 tonnes/hr, no more than about 9 tonnes/hr, no more than about 8 tonnes/hr, no more than about 7 tonnes/hr, no more than about 6 tonnes/hr, no more than about 5 tonnes/hr, no more than about 4 tonnes/hr, no more than about 3 tonnes/hr, no more than about 2 tonnes/hr, no more than about 1 tonne/hr, no more than about 900 kg/hr, no more than about 800 kg/hr, no more than about 700 kg/hr, no more than about 600 kg/hr, no more than about 500 kg/hr, no more than about 400 kg/hr, no more than about 300 kg/hr, no more than about 200 kg/hr, no more than about 100 kg/hr, no more than about 90 kg/hr, no more than about 80 kg/hr, no more than about 70 kg/hr, no more than about 60 kg/hr, no more than about 50 kg/hr, no more than about 40 kg/hr, no more than about 30 kg/hr, or no more than about 20 kg/hr of carbonated medium. Combinations of the above-referenced throughput values are also possible (e.g., at least about 10 kg/hr and no more than about 10,000 tonnes/hr or at least about 50 kg/hr and no more than about 5,000 kg/hr), inclusive of all values and ranges therebetween. In some embodiments, the TPU 100 can process about 10 kg/hr, about 20 kg/hr, about 30 kg/hr, about 40 kg/hr, about 50 kg/hr, about 60 kg/hr, about 70 kg/hr, about 80 kg/hr, about 90 kg/hr, about 100 kg/hr, about 200 kg/hr, about 300 kg/hr, about 400 kg/hr, about 500 kg/hr, about 600 kg/hr, about 700 kg/hr, about 800 kg/hr, about 900 kg/hr, about 1 tonne/hr, about 2 tonnes/hr, about 3 tonnes/hr, about 4 tonnes/hr, about 5 tonnes/hr, about 6 tonnes/hr, about 7 tonnes/hr, about 8 tonnes/hr, about 9 tonnes/hr, about 10 tonnes/hr, about 20 tonnes/hr, about 30 tonnes/hr, about 40 tonnes/hr, about 50 tonnes/hr, about 60 tonnes/hr, about 70 tonnes/hr, about 80 tonnes/hr, about 90 tonnes/hr, about 100 tonnes/hr, about 200 tonnes/hr, about 300 tonnes/hr, about 400 tonnes/hr, about 500 tonnes/hr, about 600 tonnes/hr, about 700 tonnes/hr, about 800 tonnes/hr, about 900 tonnes/hr, about 1,000 tonnes/hr, about 2,000 tonnes/hr, about 3,000 tonnes/hr, about 4,000 tonnes/hr, about 5,000 tonnes/hr, about 6,000 tonnes/hr, about 7,000 tonnes/hr, about 8,000 tonnes/hr, about 9,000 tonnes/hr, or about 10,000 tonnes/hr, of carbonated medium.

In some embodiments, the TPU 100 can process at least about 10 kg/hr, at least about 20 kg/hr, at least about 30 kg/hr, at least about 40 kg/hr, at least about 50 kg/hr, at least about 60 kg/hr, at least about 70 kg/hr, at least about 80 kg/hr, at least about 90 kg/hr, at least about 100 kg/hr, at least about 200 kg/hr, at least about 300 kg/hr, at least about 400 kg/hr, at least about 500 kg/hr, at least about 600 kg/hr, at least about 700 kg/hr, at least about 800 kg/hr, at least about 900 kg/hr, at least about 1 tonne/hr, at least about 2 tonnes/hr, at least about 3 tonnes/hr, at least about 4 tonnes/hr, at least about 5 tonnes/hr, at least about 6 tonnes/hr, at least about 7 tonnes/hr, at least about 8 tonnes/hr, at least about 9 tonnes/hr, at least about 10 tonnes/hr, at least about 20 tonnes/hr, at least about 30 tonnes/hr, at least about 40 tonnes/hr, at least about 50 tonnes/hr, at least about 60 tonnes/hr, at least about 70 tonnes/hr, at least about 80 tonnes/hr, at least about 90 tonnes/hr, at least about 100 tonnes/hr, at least about 200 tonnes/hr, at least about 300 tonnes/hr, at least about 400 tonnes/hr, at least about 500 tonnes/hr, at least about 600 tonnes/hr, at least about 700 tonnes/hr, at least about 800 tonnes/hr, at least about 900 tonnes/hr, at least about 1,000 tonnes/hr, at least about 2,000 tonnes/hr, at least about 3,000 tonnes/hr, at least about 4,000 tonnes/hr, at least at least about 5,000 tonnes/hr, at least at least about 6,000 tonnes/hr, at least at least about 7,000 tonnes/hr, at least at least about 8,000 tonnes/hr, or at least about 9,000 tonnes/hr of carbonation medium. In some embodiments, the TPU 100 can process no more than about 10,000 tonnes/hr, no more than about 9,000 tonnes/hr, no more than about 8,000 tonnes/hr, no more than about 7,000 tonnes/hr, no more than about 6,000 tonnes/hr, no more than about 5,000 tonnes/hr, no more than about 4,000 tonnes/hr, no more than about 3,000 tonnes/hr, no more than about 2,000 tonnes/hr, no more than about 1,000 tonnes/hr, no more than about 900 tonnes/hr, no more than about 800 tonnes/hr, no more than about 700 tonnes/hr, no more than about 600 tonnes/hr, no more than about 500 tonnes/hr, no more than about 400 tonnes/hr, no more than about 300 tonnes/hr, no more than about 200 tonnes/hr, no more than about 100 tonnes/hr, no more than about 90 tonnes/hr, no more than about 80 tonnes/hr, no more than about 70 tonnes/hr, no more than about 60 tonnes/hr, no more than about 50 tonnes/hr, no more than about 40 tonnes/hr, no more than about 30 tonnes/hr, no more than about 20 tonnes/hr, no more than about 10 tonnes/hr, no more than about 9 tonnes/hr, no more than about 8 tonnes/hr, no more than about 7 tonnes/hr, no more than about 6 tonnes/hr, no more than about 5 tonnes/hr, no more than about 4 tonnes/hr, no more than about 3 tonnes/hr, no more than about 2 tonnes/hr, no more than about 1 tonne/hr, no more than about 900 kg/hr, no more than about 800 kg/hr, no more than about 700 kg/hr, no more than about 600 kg/hr, no more than about 500 kg/hr, no more than about 400 kg/hr, no more than about 300 kg/hr, no more than about 200 kg/hr, no more than about 100 kg/hr, no more than about 90 kg/hr, no more than about 80 kg/hr, no more than about 70 kg/hr, no more than about 60 kg/hr, no more than about 50 kg/hr, no more than about 40 kg/hr, no more than about 30 kg/hr, or no more than about 20 kg/hr of carbonation medium. Combinations of the above-referenced throughput values are also possible (e.g., at least about 10 kg/hr and no more than about 10,000 tonnes/hr or at least about 50 kg/hr and no more than about 5,000 kg/hr), inclusive of all values and ranges therebetween. In some embodiments, the TPU 100 can process about 10 kg/hr, about 20 kg/hr, about 30 kg/hr, about 40 kg/hr, about 50 kg/hr, about 60 kg/hr, about 70 kg/hr, about 80 kg/hr, about 90 kg/hr, about 100 kg/hr, about 200 kg/hr, about 300 kg/hr, about 400 kg/hr, about 500 kg/hr, about 600 kg/hr, about 700 kg/hr, about 800 kg/hr, about 900 kg/hr, about 1 tonne/hr, about 2 tonnes/hr, about 3 tonnes/hr, about 4 tonnes/hr, about 5 tonnes/hr, about 6 tonnes/hr, about 7 tonnes/hr, about 8 tonnes/hr, about 9 tonnes/hr, about 10 tonnes/hr, about 20 tonnes/hr, about 30 tonnes/hr, about 40 tonnes/hr, about 50 tonnes/hr, about 60 tonnes/hr, about 70 tonnes/hr, about 80 tonnes/hr, about 90 tonnes/hr, about 100 tonnes/hr, about 200 tonnes/hr, about 300 tonnes/hr, about 400 tonnes/hr, about 500 tonnes/hr, about 600 tonnes/hr, about 700 tonnes/hr, about 800 tonnes/hr, about 900 tonnes/hr, about 1,000 tonnes/hr, about 2,000 tonnes/hr, about 3,000 tonnes/hr, about 4,000 tonnes/hr, about 5,000 tonnes/hr, about 6,000 tonnes/hr, about 7,000 tonnes/hr, about 8,000 tonnes/hr, about 9,000 tonnes/hr, or about 10,000 tonnes/hr, of carbonation medium.

In some embodiments, the TPU 100 can process at least about 50 trays/hr, at least about 60 trays/hr, at least about 70 trays/hr, at least about 80 trays/hr, at least about 90 trays/hr, at least about 100 trays/hr, at least about 200 trays/hr, at least about 300 trays/hr, at least about 400 trays/hr, at least about 500 trays/hr, at least about 600 trays/hr, at least about 700 trays/hr, at least about 800 trays/hr, at least about 900 trays/hr, at least about 1,000 trays/hr, at least about 2,000 trays/hr, at least about 3,000 trays/hr, at least about 4,000 trays/hr, at least about 5,000 trays/hr, at least about 6,000 trays/hr, at least about 7,000 trays/hr, at least about 8,000 trays/hr, at least about 9,000 trays/hr, at least about 10,000 trays/hr, at least about 20,000 trays/hr, at least about 30,000 trays/hr, at least about 40,000 trays/hr, at least about 50,000 trays/hr, at least about 60,000 trays/hr, at least about 70,000 trays/hr, at least about 80,000 trays/hr, or at least about 90,000 trays/hr of carbonated medium. In some embodiments, the TPU 100 can process no more than about 100,000 trays/hr, no more than about 90,000 trays/hr, no more than about 80,000 trays/hr, no more than about 70,000 trays/hr, no more than about 60,000 trays/hr, no more than about 50,000 trays/hr, no more than about 40,000 trays/hr, no more than about 30,000 trays/hr, no more than about 20,000 trays/hr, no more than about 10,000 trays/hr, no more than about 9,000 trays/hr, no more than about 8,000 trays/hr, no more than about 7,000 trays/hr, no more than about 6,000 trays/hr, no more than about 5,000 trays/hr, no more than about 4,000 trays/hr, no more than about 3,000 trays/hr, no more than about 2,000 trays/hr, no more than about 1,000 trays/hr, no more than about 900 trays/hr, no more than about 800 trays/hr, no more than about 700 trays/hr, no more than about 600 trays/hr, no more than about 500 trays/hr, no more than about 400 trays/hr, no more than about 300 trays/hr, no more than about 200 trays/hr, no more than about 100 trays/hr, no more than about 90 trays/hr, no more than about 80 trays/hr, no more than about 70 trays/hr, or no more than about 60 trays/hr of carbonated medium. Combinations of the above-referenced numbers of trays are also possible (e.g., at least about 50 trays/hr and no more than about 100,000 trays/hr or at least about 1,000 trays/hr and no more than about 10,000 trays/hr), inclusive of all values and ranges therebetween. In some embodiments, the TPU 100 can process about 50 trays/hr, about 60 trays/hr, about 70 trays/hr, about 80 trays/hr, about 90 trays/hr, about 100 trays/hr, about 200 trays/hr, about 300 trays/hr, about 400 trays/hr, about 500 trays/hr, about 600 trays/hr, about 700 trays/hr, about 800 trays/hr, about 900 trays/hr, about 1,000 trays/hr, about 2,000 trays/hr, about 3,000 trays/hr, about 4,000 trays/hr, about 5,000 trays/hr, about 6,000 trays/hr, about 7,000 trays/hr, about 8,000 trays/hr, about 9,000 trays/hr, about 10,000 trays/hr, about 20,000 trays/hr, about 30,000 trays/hr, about 40,000 trays/hr, about 50,000 trays/hr, about 60,000 trays/hr, about 70,000 trays/hr, about 80,000 trays/hr, about 90,000 trays/hr, or about 100,000 trays/hr of carbonated medium.

In some embodiments, one or more weigh stations can be placed at various locations throughout the TPU 100. In some embodiments, the weigh station(s) can include scales. In some embodiments, a weigh station can be incorporated into the tray mover 130a and/or the tray mover 130b. In some embodiments, a weigh station can be incorporated into the loader 140a and/or the unloader 140b. In some embodiments, a weigh station can be incorporated into the collection station 120. In some embodiments, a weigh station can be incorporated into the filling station 110. In some embodiments, a weigh station can be placed at any location between the aforementioned process units.

In some embodiments, one or more quality inspection stations can be placed at various locations throughout the TPU 100. In some embodiments, the quality inspection station(s) can include an inspection tool. In some embodiments, the quality inspection station(s) can include an optical measurement device. In some embodiments, the optical measurement device can measure the level and/or uniformity (i.e., evenness) of carbonation medium or carbonated medium in a tray. In some embodiments, a quality inspection station can be incorporated into the tray mover 130a and/or the tray mover 130b. In some embodiments, a quality inspection station can be incorporated into the loader 140a and/or the unloader 140b. In some embodiments, a quality inspection station can be incorporated into the collection station 120. In some embodiments, a quality inspection station can be incorporated into the filling station 110. In some embodiments, a quality inspection station can be placed at any location between the aforementioned process units.

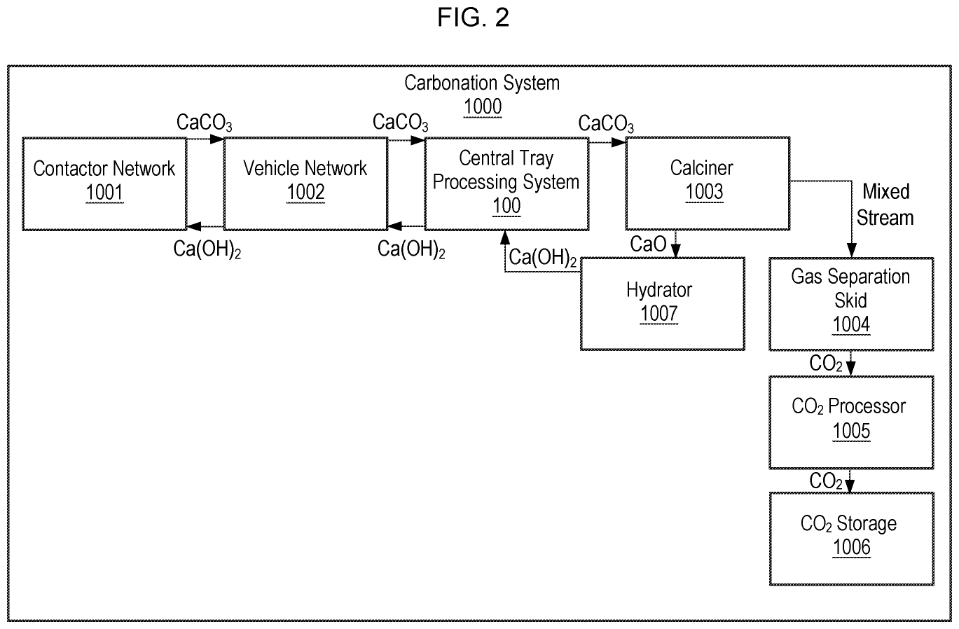

FIG. 2 is a block diagram of a carbonation system 1000, according to an embodiment. FIG. 2 shows how the TPU 100 incorporates into a larger scheme. As shown, the carbonation system 1000 includes a contactor network 1001, a vehicle network, the TPU 100, a calciner 1003, a gas separation skid 1004, a CO₂ processor 1005, and CO₂ storage 1006.

The contactor network 1001 includes an array of contactors. In some embodiments, the contactors can have any of the properties of the contactors described in the '602 application. The vehicle network 1002 aids in transporting carbonation medium and carbonated medium between the contactor network 1001 and the TPU 100. In some embodiments, the vehicle network 1002 can include one or more AGV's. In some embodiments, the vehicle network 1002 can include a first vehicle and a second vehicle. In some embodiments, the first vehicle can transport caddies while the second vehicle is charging at a charging station. In some embodiments, the second vehicle can transport caddies while the first vehicle is charging at the charging station. In some embodiments, the vehicle network 1002 can include about 1, about 2, about 3, about 4, about 5, about 6, about 7, about 8, about 9, about 10, about 20, about 30, about 40, about 50, about 60, about 70, about 80, about 90, about 100, about 200, about 300, about 400, about 500, about 600, about 700, about 800, about 900, or about 1,000 vehicles, inclusive of all values and ranges therebetween. In some embodiments, any of the vehicles can include a lifter module configured to dock and undock caddies (i.e., from a loading dock and/or an unloading dock). The calciner 1003 converts carbonated medium to carbonation medium. In some embodiments, the calciner 1003 can have any of the properties of the calciners described in the '896 application.

The gas separation skid 1004 separates CO₂ in the exhaust from the calciner 1003 from other gases. In some embodiments, the gas separation skid 1004 can include a condenser to remove water. The CO₂ processer 1005 further separates gases to purify the CO₂. In some embodiments, the CO₂ processor 1005 can include a compressor to pressurize the CO₂. The CO₂ storage 1006 includes a volume for storage and sequestration of CO₂. In some embodiments, the CO₂ storage 1006 can have any of the properties described in the '896 application.

FIG. 2 depicts the movement of chemicals from one process block to another. The chemicals shown in FIG. 2 are intended as examples and not intended to limit the scope of this application. As shown, CaCO₃ is transported from the contactor network 1001 to the TPU 100 via the vehicle network 1002 and Ca(OH)₂ is transported from the TPU 100 to the contactor network 1001 via the vehicle network 1002. CaCO₃ is transported from the TPU 100 to the calciner 1003 and a mixed stream of gases move from the calciner 1003 to the gas separation skid 1004. A high purity CO₂ stream moves from the gas separation skid 1004 to the CO₂ processor 1005 and a higher purity CO₂ stream moves from the CO₂ processor 1005 to the CO₂ storage 1006. A stream of CaO moves from the calciner 1003 to the hydrator 1007, where the CaO is hydrated to become Ca(OH)₂. The Ca(OH)₂ is then fed to the TPU 100.

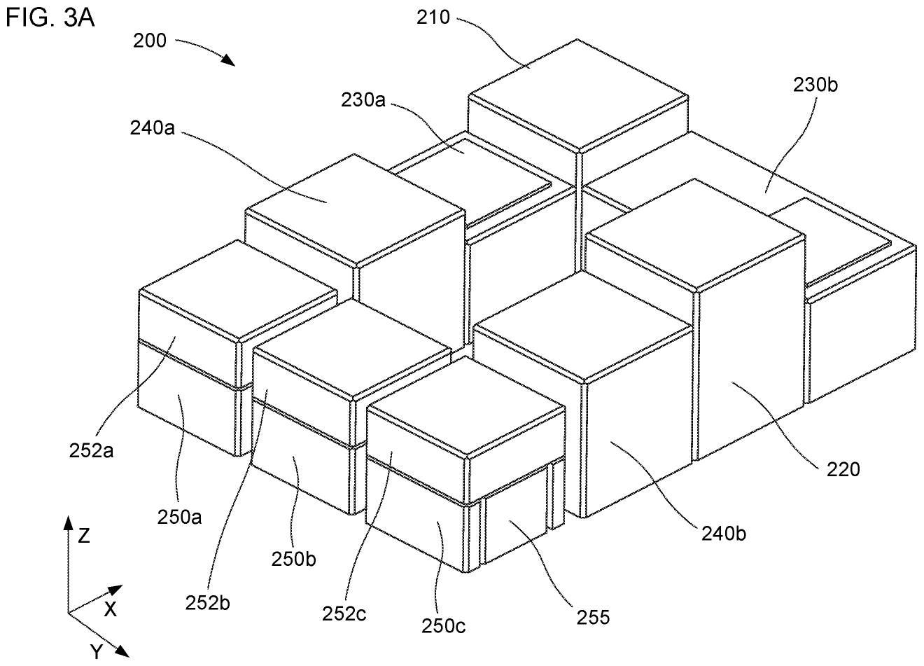

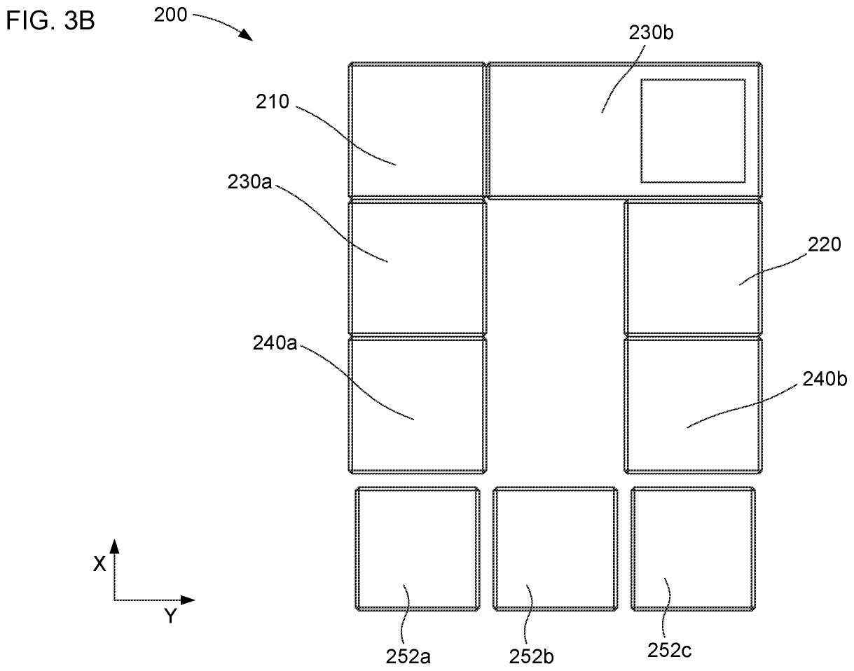

FIGS. 3A-3B show the layout of a TPU 200, according to an embodiment. FIG. 3A shows a perspective view of the TPU 200, while FIG. 3B shows an overhead view of the TPU 200. Axes are shown for structural clarity. As shown, the TPU 200 includes a filling station 210, a collection station 220, tray movers 230a, 230b (collectively referred to as tray movers 230), a loader 240a, an unloader 240b (collectively referred to as distributors 240), docking stations 250a, 250b, 250c (collectively referred to as docking stations 250), caddies 252a, 252b, 252c (collectively referred to as caddies 250), and a vehicle 255. In some embodiments, the filling station 210, the collection station 220, the tray movers 230, the distributors 240, and the docking stations 250 can be the same or substantially similar to the filling station 110, the collection station 120, the tray movers 130, the loader 140a, the unloader 140b, and the docking station 150, as described above with reference to FIG. 1. Thus, certain aspects of the filling station 210, the collection station 220, the tray movers 230, the loader 240a, the unloader 240b, and the docking stations 250 are not described in greater detail herein.

In use, the docking station 250c can act as a loading station, while the docking station 250a can act as an unloading station for trays. Trays can be loaded or unloaded from docking station 250b. In some embodiments, the docking station 250b can act as a buffer station. In some embodiments, the docking station 250b can be used for loading and/or unloading of trays. In some embodiments, either of the docking stations 250 can be used for loading or unloading of trays and conveyors in the docking stations 250 can aid in moving the trays to an appropriate location. As shown, the TPU 200 includes 3 docking stations 250. In some embodiments, the TPU 200 can include about 1, about 2, about 3, about 4, about 5, about 6, about 7, about 8, about 9, about 10, about 20, about 30, about 40, about 50, about 60, about 70, about 80, about 90, or about 100 docking stations, inclusive of all values and ranges therebetween.

In use, the vehicle 255 delivers the caddy 252c to the docking station 250c. The unloader 240b then transfers trays from the caddy 252c to the collection station 220 where the carbonated medium is collected. The tray mover 230b then transfers the empty or nearly empty trays from the collection station 220 to the filling station 210 where carbonation medium is dispensed into the trays. The tray mover 230a then transfers the trays to the loader 240a, which delivers the trays to the caddy 252a. Another vehicle (not shown) then delivers the caddy 252a to a contactor system. In some embodiments, the same vehicle 255 can deliver and collect the caddies 252. In some embodiments, the docking stations 250 can include rollers or conveyors to move the caddies 252 between the docking stations 250.

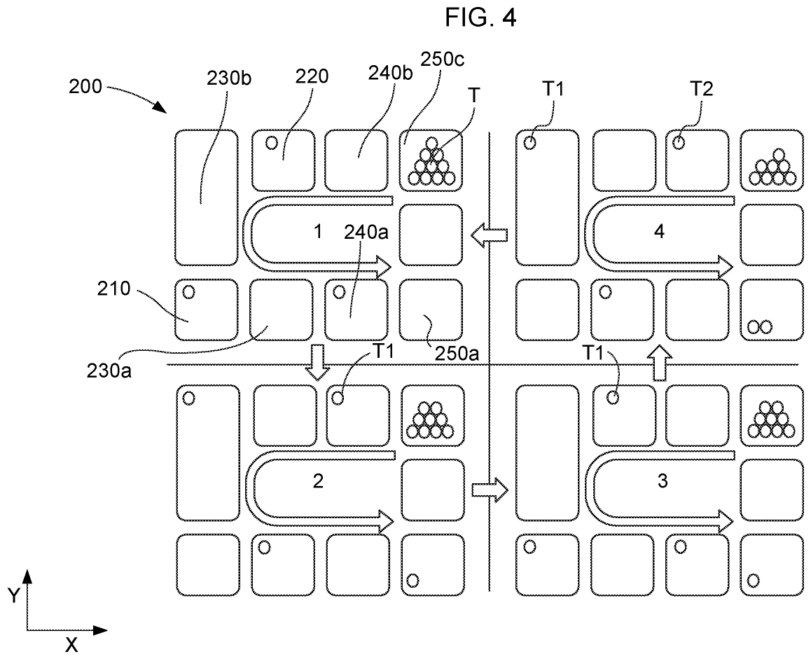

FIG. 4 is an overhead depiction of movement of trays T throughout the TPU 200. Axes are shown for structural clarity. In step 1, 10 trays T are included in the docking station 250c while additional trays T are scattered throughout the TPU 200. In step 2, a tray T1 has migrated from the docking station 250c to the unloader 240b. In step 3, the same tray T1 that migrated to the unloader 240b in step 2 has now migrated to the collection station 220. In step 4, the same tray T1 that migrated to the collection station 220 at step 3 has migrated to the tray mover 230b and an additional tray T2 has now migrated from the docking station 250c to the unloader 240b.

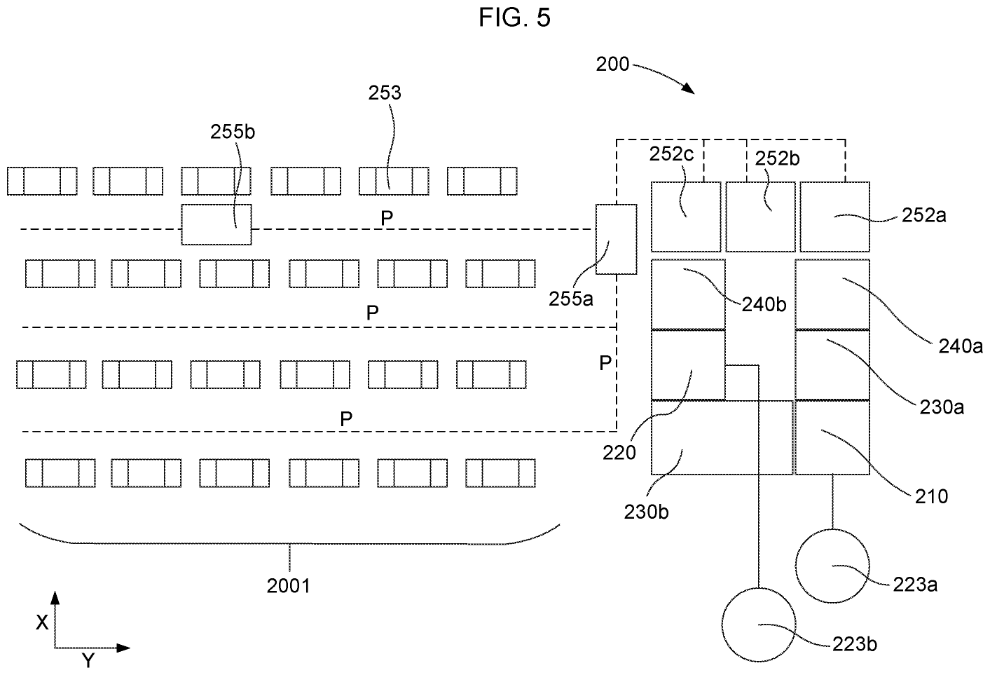

FIG. 5 shows movement of the vehicle 255 between the TPU 200 and a contactor system 2001. In some embodiments, the contactor system 2001 can be the same or substantially similar to the contactor system 1001, as described above with reference to FIG. 2. Thus, certain aspects of the contactor system 2001 are not described in greater detail herein. As shown, the contactor system 2001 includes rows of contactor units. Pathways P define movement paths of the vehicle 255 between the TPU 200 and the contactor system 2001. The pathways are positioned between the rows of contactors. As shown, the TPU 200 includes silos 223a, 223b (collectively referred to as silos 223). Carbonated medium is transferred from the silo 223a to the filling station 210. In some embodiments, carbonated medium can be transferred from the silo 223a to the filling station 210 via a vacuum installed at the filling station 210. In some embodiments, carbonated medium can be transferred from the silo 223a to the filling station 210 via an auger. In some embodiments, the carbonation medium can be transferred from the silo 223a to the filling station 210 via pneumatic conveyance (i.e., positive pressure conveyance). Carbonation medium is transferred from the collection station 220 to the silo 223b for storage. In some embodiments, the vehicle 255 can be powered via solar power, wind power, nuclear power, geothermal power, and/or any other suitable renewable or low carbon energy source or combinations thereof.

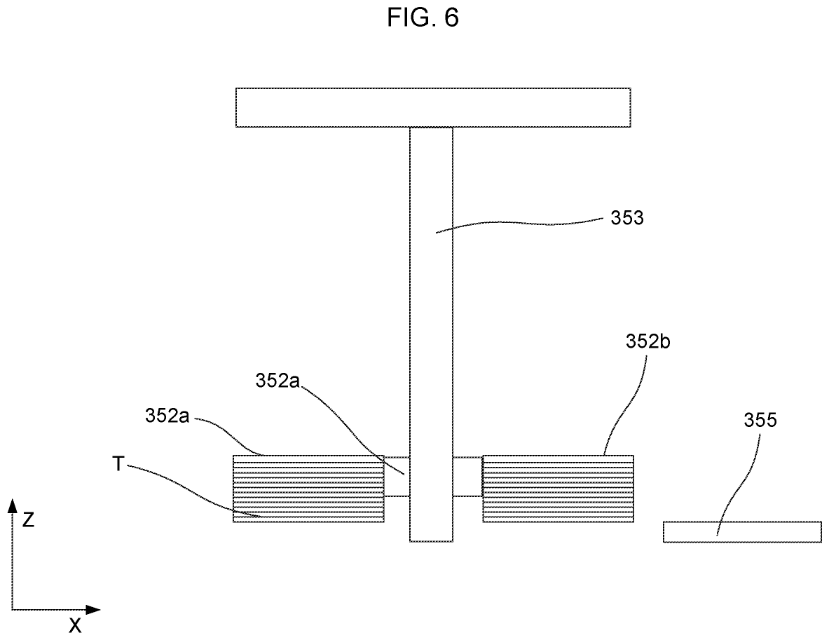

FIG. 6 shows interactions between a contactor tower 353, caddies 352a, 352b (collectively referred to as caddies 352), and a vehicle 355, according to an embodiment. Axes are shown for structural clarity. In some embodiments, the contactor tower 353 can be the same or substantially similar to the contactor towers described in the '602 application. In some embodiments, the caddies 352 and the vehicle 355 can be the same or substantially similar to the caddies 252 and the vehicle 255 as described above with reference to FIGS. 3A-3B. Thus, certain aspects of the caddies 352, the contactor tower 353, and the vehicle 355 are not described in greater detail herein.

In use, the vehicle 355 moves to a position under the contactor tower 353 and retrieves the caddies 352. The vehicle 355 can also transport the caddies 352 and move to place the caddies 352 in a desired vertical position on the contactor tower 353. In some embodiments, multiple caddies 352 can be stacked upon each other in the contactor tower 353. In some embodiments, the contactor tower 353 can include an elevator to elevate and move caddies 352 to a desired vertical position. As shown, trays T are stacked within the caddies 352. In some embodiments, the trays T can be positioned in the contactor tower 353 while dissociated from the caddies 352.

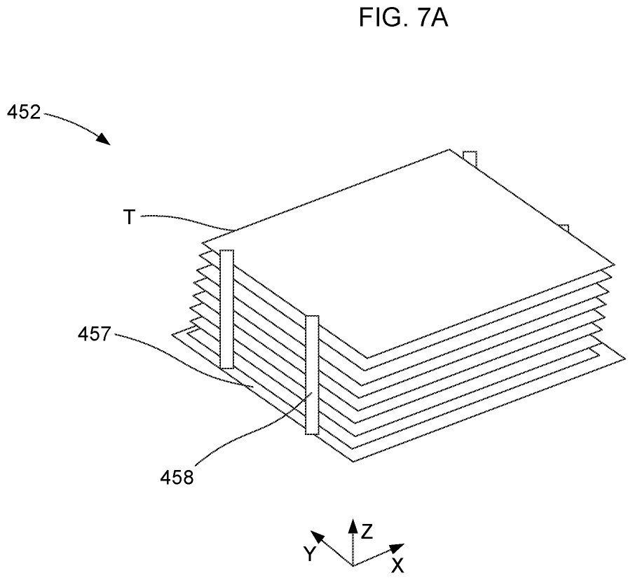

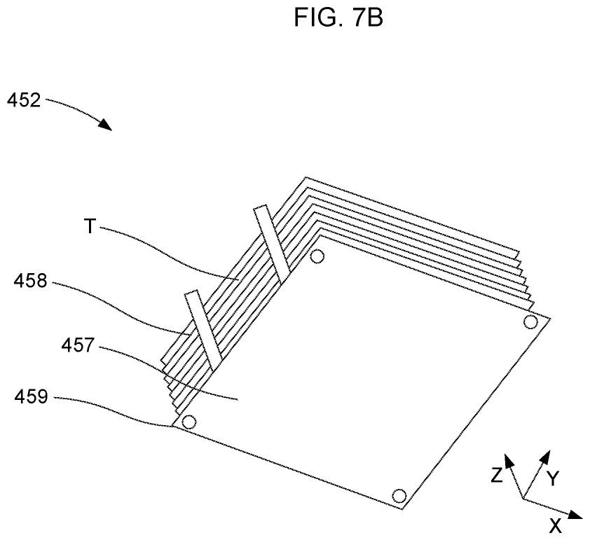

FIGS. 7A-7B show a caddy 452, according to an embodiment. FIG. 7A shows an overhead perspective view of the caddy 452, while FIG. 7B shows a perspective view from an underside of the caddy 452. Axes are shown for structural clarity. As shown, the caddy 452 includes a caddy-vehicle interface 457 and support structures 458.

The caddy-vehicle interface 457 provides a surface for lifting the caddy along the height of the contactor tower 453. In some embodiments, the caddy-vehicle interface 457 can include a platform that can be contacted by an arm or lifting device. As shown, the caddy-vehicle interface 457 includes fastener holes 459 for securing or attachment of the caddy 452 to pieces of process equipment. The support structure 458 keeps trays T in a proper alignment along the height of the contactor tower 453. In some embodiments, the support structure 458 can include a series of beams or poles that prevent movement of the trays T along the x- and y-axes.

As shown, 10 trays T are stacked on the caddy 452. In some embodiments, at least about 1, at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, at least about 200, at least about 300, at least about 400, at least about 500, at least about 600, at least about 700, at least about 800, or at least about 900 trays T can be stacked on the caddy 452. In some embodiments, no more than about 1,000, no more than about 900, no more than about 800, no more than about 700, no more than about 600, no more than about 500, no more than about 400, no more than about 300, no more than about 200, no more than about 100, no more than about 90, no more than about 80, no more than about 70, no more than about 60, no more than about 50, no more than about 40, no more than about 30, no more than about 20, no more than about 10, no more than about 9, no more than about 8, no more than about 7, no more than about 6, no more than about 5, no more than about 4, no more than about 3, or no more than about 2 trays T can be stacked on the caddy 452. Combinations of the above-referenced numbers of trays T are also possible (e.g., at least about 1 and no more than about 1,000 or at least about 5 and no more than about 50), inclusive of all values and ranges therebetween. In some embodiments, about 1, about 2, about 3, about 4, about 5, about 6, about 7, about 8, about 9, about 10, about 20, about 30, about 40, about 50, about 60, about 70, about 80, about 90, about 100, about 200, about 300, about 400, about 500, about 600, about 700, about 800, about 900, or about 1,000, trays T can be stacked on the caddy 452.

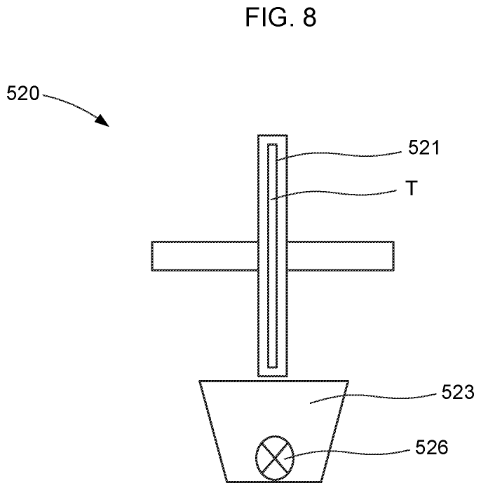

FIG. 8 shows a collection station 520, according to an embodiment. As shown, the collection station 520 includes an enclosure 521, a trough 523, and an auger 526. The enclosure 521 can house a tray T. In some embodiments, the enclosure 521 can include openings for outflow of carbonated medium. In some embodiments, the enclosure 521 can include a long, narrow opening on a narrow side of the enclosure 521. The tray T is held to prevent the tray T from falling through the opening and the carbonated medium is allowed to fall from the tray T into the trough 523. In some embodiments, the enclosure 521 can include an arm to hold the tray T. In some embodiments, the enclosure 521 can rotate. In some embodiments, the collection station 520 can include a robotic arm that rotates the enclosure 521. In some embodiments, the collection station 520 can include an agitator to vibrate the enclosure 521 and the tray T to facilitate falling out of the carbonated medium.

In some embodiments, the enclosure 521 can rotate by at least about 30 degrees, at least about 30 degrees, at least about 30 degrees, at least about 40 degrees, at least about 50 degrees, at least about 60 degrees, at least about 70 degrees, at least about 80 degrees, at least about 90 degrees, at least about 100 degrees, at least about 110 degrees, at least about 120 degrees, at least about 130 degrees, at least about 140 degrees, at least about 150 degrees, at least about 160 degrees, or at least about 170 degrees. In some embodiments, the enclosure 521 can rotate by no more than about 180 degrees, no more than about 170 degrees, no more than about 160 degrees, no more than about 150 degrees, no more than about 140 degrees, no more than about 130 degrees, no more than about 120 degrees, no more than about 110 degrees, no more than about 100 degrees, no more than about 90 degrees, no more than about 80 degrees, no more than about 70 degrees, no more than about 60 degrees, no more than about 50 degrees, or no more than about 40 degrees. Combinations of the above-referenced angles are also possible (e.g., at least about 30 degrees and no more than about 180 degrees or at least about 80 degrees and no more than about 120 degrees), inclusive of all values and ranges therebetween. In some embodiments, the enclosure 521 can rotate by about 30 degrees, about 30 degrees, about 30 degrees, about 40 degrees, about 50 degrees, about 60 degrees, about 70 degrees, about 80 degrees, about 90 degrees, about 100 degrees, about 110 degrees, about 120 degrees, about 130 degrees, about 140 degrees, about 150 degrees, about 160 degrees, about 170 degrees, or about 180 degrees.

The trough 523 provides a volume where the carbonated medium can collect after falling from the tray T. In some embodiments, the trough 523 can include a hopper. The auger 526 facilitates movement of the carbonated medium out of the trough 523. In some embodiments, the auger 526 can deliver the carbonated medium directly to a calciner. In some embodiments, the auger 526 can deliver the carbonated medium to a storage area (e.g., a silo).

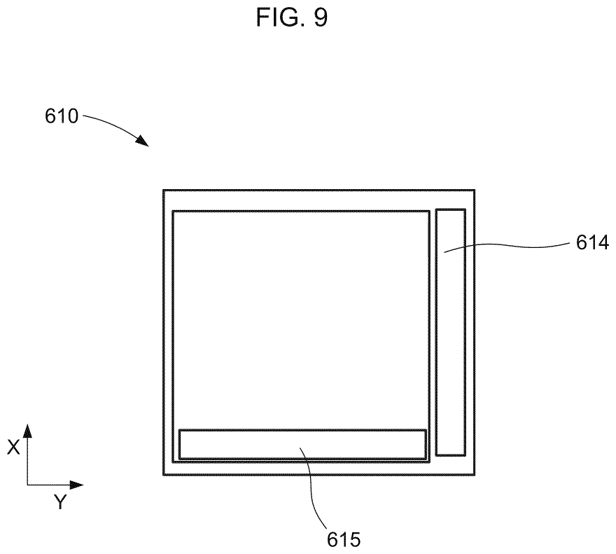

FIG. 9 shows an overhead view of a filling station 610, according to an embodiment. Axes are shown for structural clarity. As shown, the filling station 610 includes a tray filler 614 and a water dispenser 615. Carbonation medium is dispensed into a tray as the tray moves into the filling station 610. The water dispenser 615 delivers water to the tray. In some embodiments, the water can be delivered to the tray after the carbonation medium is dispensed into the tray. In some embodiments, the water can be delivered to the tray before the carbonation medium is dispensed into the tray. In some embodiments, the water can be delivered to the tray as the carbonation medium is being dispensed into the tray. As described above, the water can improve uptake of the carbonation medium and can adhere the carbonation medium together, creating a crust-like material. In some embodiments, the water dispenser 615 can include a spray nozzle.

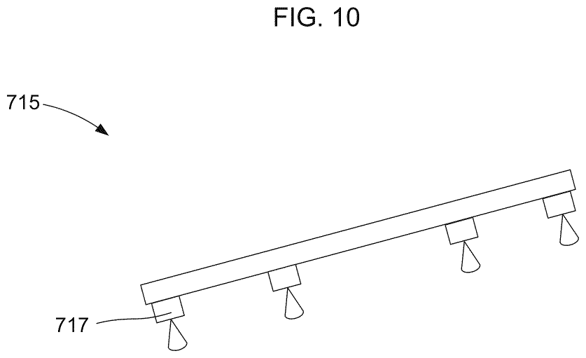

FIG. 10 shows a water dispenser 715, according to an embodiment. In some embodiments, the water dispenser 715 can be the same or substantially similar to the water dispenser 615, as described above with reference to FIG. 9. Thus, certain aspects of the water dispenser 715 are not described in greater detail herein. As shown, the water dispenser 715 includes spray nozzles 717. As shown, the spray nozzles 717 are arranged in a single file. In some embodiments, the spray nozzles can be arranged in a 2-dimensional n×m array, where n and m are both integers. In some embodiments, n and/or m can be about 1, about 2, about 3, about 4, about 5, about 6, about 7, about 8, about 9, about 10, about 11, about 12, about 13, about 14, about 15, about 16, about 17, about 18, about 19, or about 20, inclusive of all values and ranges therebetween.

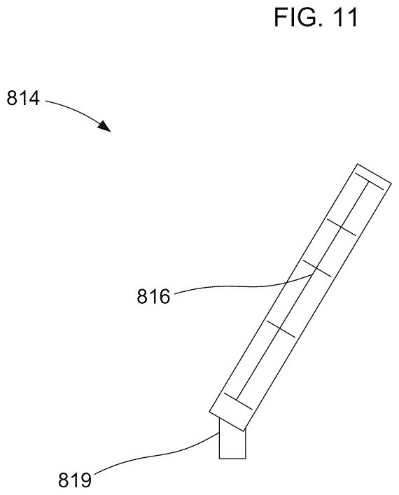

FIG. 11 shows a tray filler 814, according to an embodiment. As shown, the tray filler 814 includes a carbonation medium reservoir 816 and a dispensing nozzle 819. The carbonation medium reservoir 816 stores carbonation medium. In some embodiments, the carbonation medium reservoir 816 can include an auger for movement of carbonation medium through the carbonation medium reservoir 816. The dispensing nozzle 819 dispenses carbonation medium. In some embodiments, the dispensing nozzle 819 can include one or more valves to regulate outflow of carbonation medium.

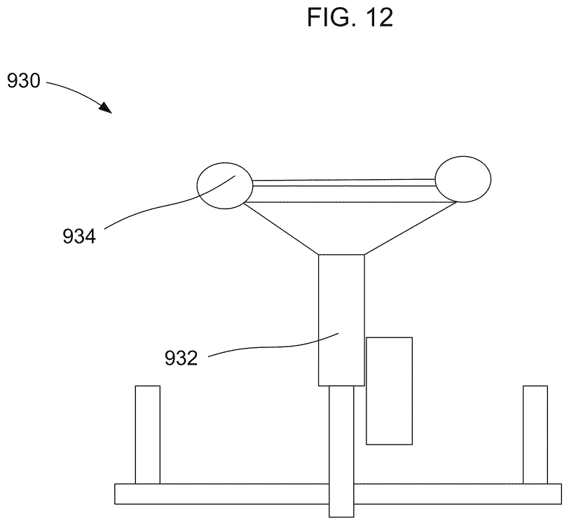

FIG. 12 shows a tray mover 930, according to an embodiment. In some embodiments, the tray mover 930 can be the same or substantially similar to the tray mover 130, as described above with reference to FIG. 1. As shown, the tray mover includes an actuator 932 and grommets 934. The actuator 932 propels horizontal movement of trays along the tray mover 930. In some embodiments, the actuator 932 can include a linear actuator. The grommets 934 provide a location for placement of trays on top of the tray mover 930. In some embodiments, the grommets 934 can be moved via effector pins. In some embodiments, the grommets 934 can be combined with passive rollers or active roller conveyors. In some embodiments, the grommets 934 can enable 2-direction translation. In some embodiments, the grommets 934 can enable tray velocity profile control.

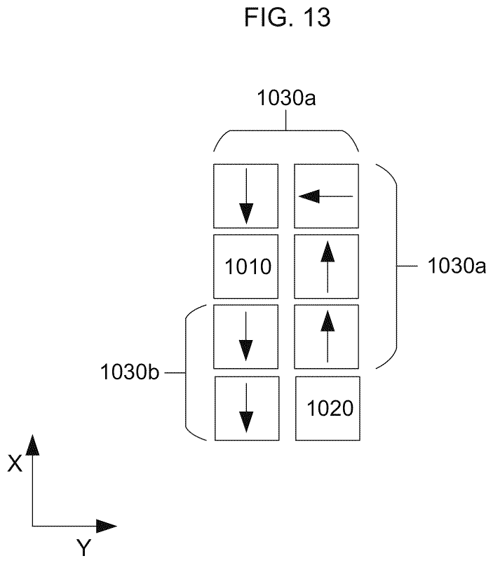

FIG. 13 shows a tray movement scheme, according to an embodiment. FIG. 13 shows an overhead view of a filling station 1010, a collection station 1020, and tray movers 1030a, 1030b (collectively referred to as tray movers 1030). Axes are shown for structural clarity. As shown, the filling station 1010, the collection station 1020, and the tray movers 1030 can be the same or substantially similar to the filling station 210, the collection station 220, and the tray movers 230, as described above with reference to FIGS. 3A-3B. Thus, certain aspects of the filling station 1010, the collection station 1020, and the tray movers 1030 are not described in greater detail herein. As shown, empty trays exit the collection station moving along two platforms of the tray mover 1030a in the positive x-direction. A next platform of the tray mover 1030a moves the tray in the negative y-direction. A next platform of the tray mover 1030a moves the tray in the negative x-direction toward the filling station 1010. Two more platforms of the tray mover 1030b then move the tray in the negative x-direction toward a loading dock (not shown).

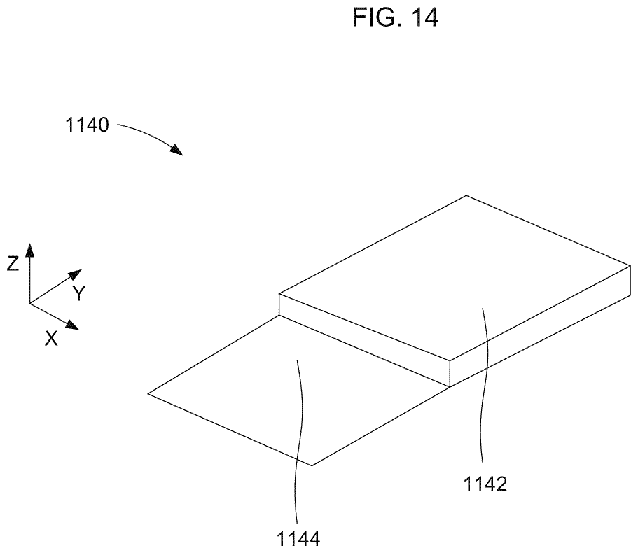

FIG. 14 shows a tray distributor 1140, according to an embodiment. In some embodiments, the tray distributor 1140 can be the same or substantially similar to the loader 240a and/or the unloader 240b, as described above with reference to FIGS. 3A-3B. Thus, certain aspects of the tray distributor 1140 are not described in greater detail. Axes are shown for structural clarity. In some embodiments, the tray distributor 1140 can function as a tray loader. In some embodiments, the tray distributor 1140 can function as a tray unloader. The distributor 1140 moves the trays vertically along the z-axis. As shown, the distributor 1140 includes a housing 1142 and a platform 1144. The platform 1144 moves into and out of the housing 1142 (i.e., along x-axis). A tray can be placed upon the platform 1144. In some embodiments, the movement of the platform 1144 into and out of the housing 1142 can be via wheels. In some embodiments, the wheels can move through a track. In some embodiments, the movement of the platform 1144 can be automated. In some embodiments, the platform 1144 can be the same or substantially similar to the platforms described with respect to the contactors in the '602 application.

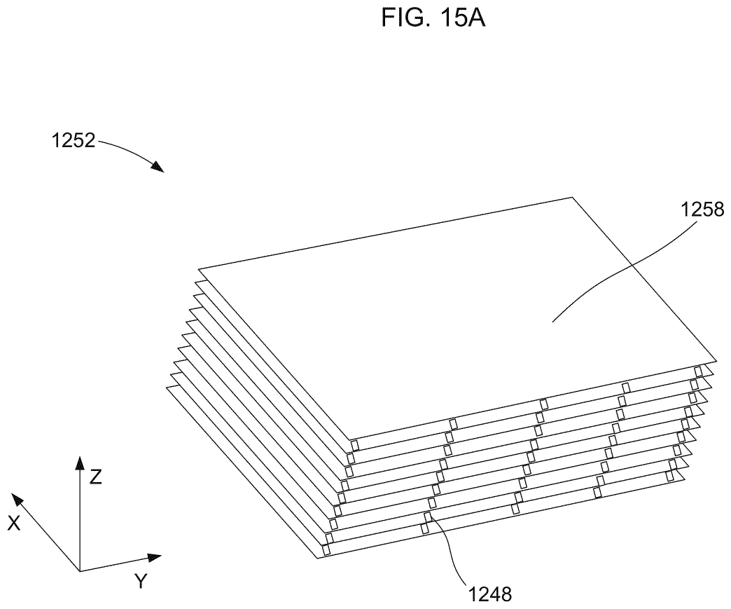

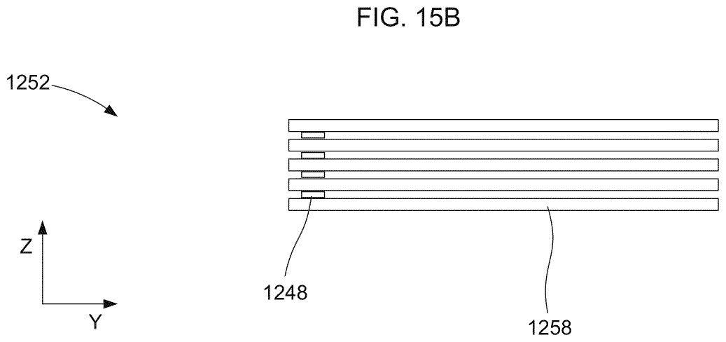

FIGS. 15A-15B show a caddy 1252, according to an embodiment. FIG. 15A shows a perspective view of the caddy 1252, while FIG. 15B shows a side view of the caddy 1252. Axes are shown for structural clarity. As shown, the caddy 1252 includes support structures 1258 and bars 1248. The support structures 1258 act as shelves for the placement of trays. The support structures 1258 are placed on top of the bars 1248. The bars 1248 extend lengthwise along the caddy 1252.

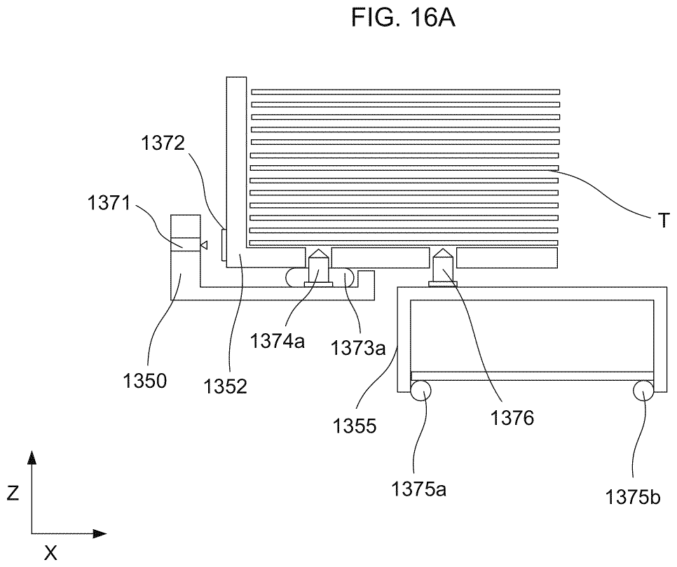

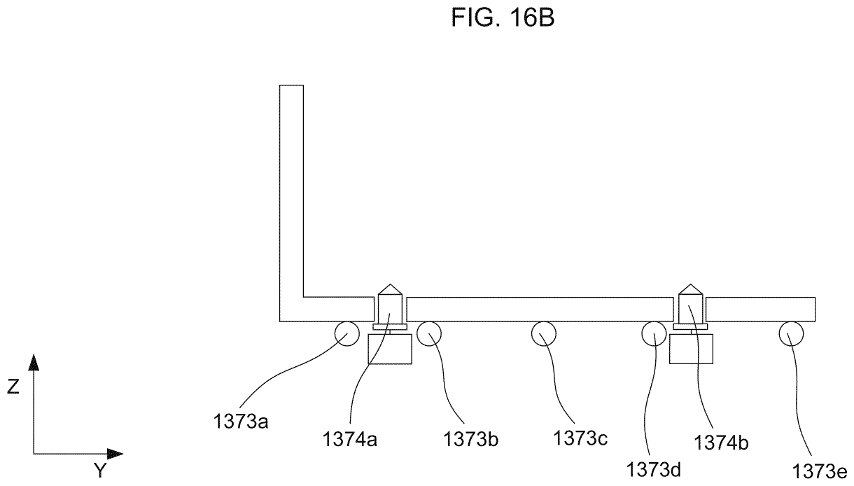

FIGS. 16A-16B show interaction between a docking station 1350, a caddy 1352, and a vehicle 1355, according to an embodiment. FIG. 16A shows a front view of the components, while FIG. 16B shows a side view of the components. Axes are shown for structural clarity. In some embodiments, the docking station 1350, the caddy 1352, and the vehicle 1355 can be the same or substantially similar to the docking station 250, the caddy 252, and the vehicle 255, as described above with reference to FIGS. 3A-3B. Thus, certain aspects of the docking station 1350, the caddy 1352, and the vehicle 1355 are not described in greater detail herein.

As shown, the docking station 1350 includes a detector 1371, a label 1372, rollers 1373a, 1373b, 1373c, 1373d, 1373e (collectively referred to as rollers 1373), and locating pins 1374a, 1374b (collectively referred to as locating pins 1374). The rollers 1373 facilitate movement of the caddy 1352 into and out of the docking station 1350. The locating pins 1374 lock the caddy 1352 in place when the caddy 1352 moves into position on the docking station 1350. In some embodiments, the locating pins 1374 can be spring loaded. In some embodiments, the locating pins 1374 can be automated. The label 1372 provides an identifying mark for the caddy 1352. In some embodiments, the label 1372 can include data stored in a central database. The detector 1371 detects the label 1372. In some embodiments, the detector 1371 can send information to a central computer for tracking. As shown, the caddy 1352 includes a stack of trays T disposed therein.

As shown, the vehicle 1355 includes wheels 1375a, 1375b (collectively referred to as wheels 1375) and a locating pin 1376. The wheels 1375 allow the vehicle 1355 to move around the floor of the facility. The locating pin 1376 locks the vehicle 1355 to the caddy 1352. In some embodiments, the vehicle 1355 can include a spring. In some embodiments, the vehicle 1355 can be automated.

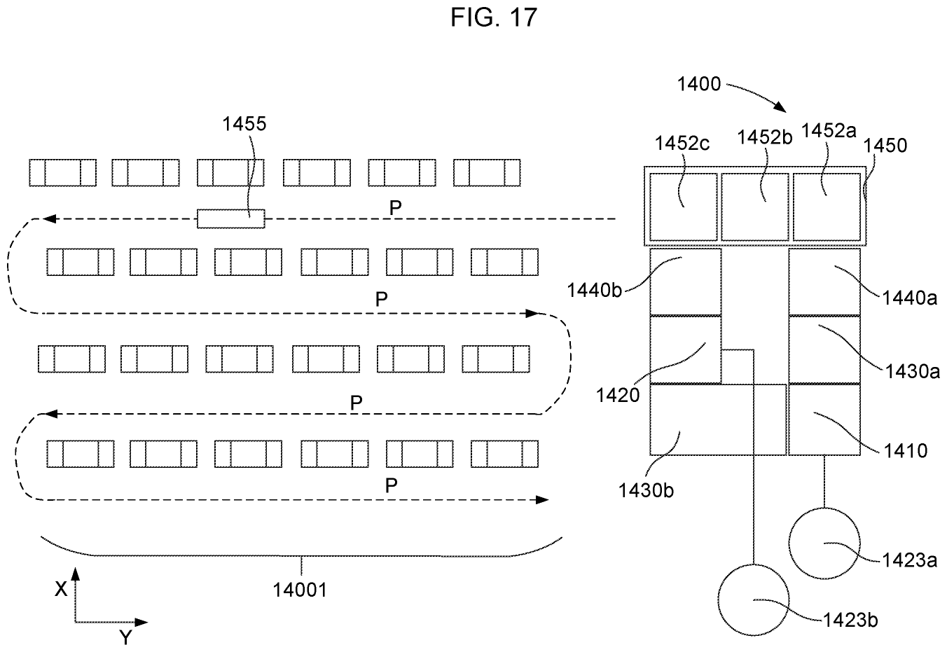

FIG. 17 is an overhead view of a TPU 1400 and a contactor network 14001. Axes are shown for structural clarity. As shown, the TPU 1400 includes a filling station 1410, a collection station 1420, silos 1423a, 1423b (collectively referred to as silos 1423), tray movers 1430a, 1430b (collectively referred to as tray movers 1430), a loader 1440a, an unloader 1440b, a docking station 1450, caddies 1452a, 1452b, 1452c (collectively referred to as caddies 1452), and a vehicle 1455. In some embodiments, the TPU 1400, the contactor network 14001, the filling station 1410, the collection station 1420, the silos 1423, the tray movers 1430, the loader 1440a, the unloader 1440b, the docking station 1450, the caddies 1452, and the vehicle 1455 can be the same or substantially similar to the TPU 200, the contactor network 2001, the filling station 210, the collection station 220, the silos 223, the tray movers 230, the loader 240a, the unloader 240b, the docking station 250, the caddies 252, and the vehicles 255, as described above with reference to FIG. 5. Thus, certain aspects of the TPU 1400, the contactor network 14001, the filling station 1410, the collection station 1420, the silos 1423, the tray movers 1430, the loader 1440a, the unloader 1440b, the docking station 1450, the caddies 1452, and the vehicle 1455 are not described in greater detail herein.

As shown, pathways P between the contactors of the contactor network 14001 allow for one-way movement between the contractors. This allows the vehicle 1455 to weave through arrays of contactors of the contactor network 14001. The vehicle 1455 moves in a first direction through a first lane and a second direction in a second lane adjacent to the first lane, the second direction opposite the first direction.

FIG. 17 shows a single TPU 1400 in a facility. In some embodiments, multiple TPU's can be included in a single facility. In some embodiments, a facility can include about 1, about 2, about 3, about 4, about 5, about 6, about 7, about 8, about 9, about 10, about 20, about 30, about 40, about 50, about 60, about 70, about 80, about 90, or about 100 TPU's, inclusive of all values and ranges therebetween.

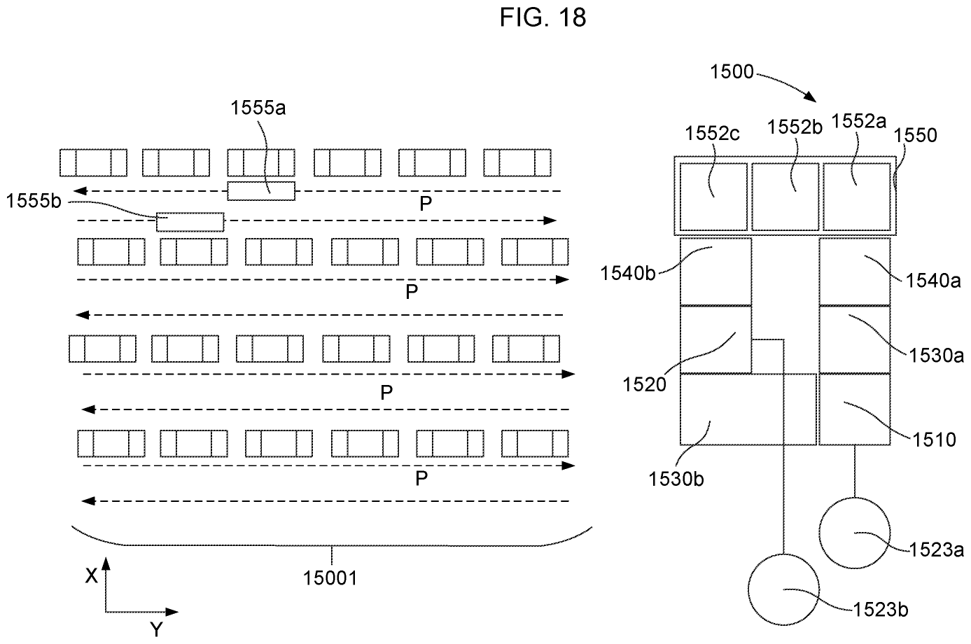

FIG. 18 is an overhead view of a TPU 1500 and a contactor network 15001. Axes are shown for structural clarity. As shown, the TPU 1500 includes a filling station 1510, a collection station 1520, silos 1523a, 1523b (collectively referred to as silos 1523), tray movers 1530a, 1530b (collectively referred to as tray movers 1530), a loader 1540a, an unloader 1540b, a docking station 1550, caddies 1552a, 1552b, 1552c (collectively referred to as caddies 1552), and vehicles 1555a, 1555b (collectively referred to as vehicles 1555). In some embodiments, the TPU 1500, the contactor network 15001, the filling station 1510, the collection station 1520, the silos 1523, the tray movers 1530, the loader 1540a, the unloader 1540b, the docking station 1550, the caddies 1552, and the vehicles 1555 can be the same or substantially similar to the TPU 200, the contactor network 2001, the filling station 210, the collection station 220, the silos 223, the tray movers 230, the loader 1540a, the unloader 1540b, the docking station 250, the caddies 252, and the vehicle 255, as described above with reference to FIG. 5. Thus, certain aspects of the TPU 1500, the contactor network 15001, the filling station 1510, the collection station 1520, the silos 1523, the tray movers 1530, the loader 1540a, the unloader 1540b, the docking station 1550, the caddies 1552, and the vehicles 1555 are not described in greater detail herein.

As shown, pathways P between the contactors of the contactor network 15001 allow for two-way movement between the contractors. This allows the vehicles 1555 to move in either direction between the contactors. In some embodiments, the vehicles 1555 can drive on the right side of the lanes between the contactors, from the perspective of the vehicles 1555 (i.e., American driving scheme). In some embodiments, the vehicles 1555 can drive on the left side of the lanes between the contactors, from the perspective of the vehicles 1555 (i.e., British driving scheme).

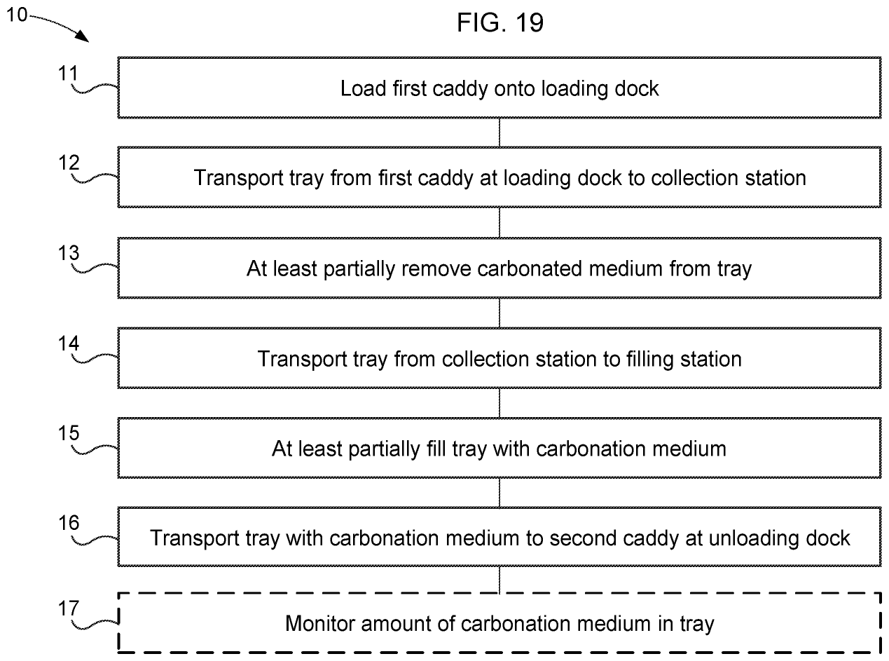

FIG. 19 shows a flow diagram of a method 10 of processing trays in a carbonation system, according to an embodiment. As shown, the method 10 includes loading a first caddy onto a loading dock at step 11, transporting a tray from the first caddy at the loading dock to a collection station at step 12, at least partially removing a carbonated medium from the tray at step 13, transporting the tray from the collection station to a filling station at step 14, at least partially filling the tray with a carbonation medium 15, transporting the tray with carbonation medium to a second caddy at an unloading dock at step 16, and optionally an amount of carbonation medium in a tray at step 17.

Step 11 includes loading the first caddy onto the loading dock. In some embodiments, loading the first caddy onto the loading dock can be via a vehicle. The first caddy can be transported from a contactor system including an array of contactors. Step 12 includes transporting the tray from the first caddy at the loading dock to the collection station. In some embodiments, step 12 can include elevating or lowering the tray via a distributor. In some embodiments, step 12 can include conveying the tray (e.g., via a belt conveyor).

Step 13 includes at least partially removing the carbonated medium from the tray. In some embodiments, step 13 can include removing all or substantially all of the carbonated medium from the tray. In some embodiments, the carbonated medium can be collected in a trough or a hopper. In some embodiments, the carbonated medium can be transported from the collection station to a silo. In some embodiments, transporting the carbonated medium from the collection station to the silo can be via a conveyor. In some embodiments, the conveyor can include an auger.

Step 14 transporting the tray from the collection station to the filling station. In some embodiments, step 14 can include elevating or lowering the tray via a distributor. In some embodiments, step 14 can include conveying the tray (e.g., via a belt conveyor). Step 15 includes at least partially filling the tray with a carbonation medium. In some embodiments, the carbonation medium can be dispensed via a dispensation device. In some embodiments, water can be added to the carbonation medium. In some embodiments, water can be added to the carbonation medium at the filling station. In some embodiments, water can be added to the carbonation medium after the tray has left the filling station. In some embodiments, the carbonation medium can be transported to the dispensation device from an auger. In some embodiments, the transportation of the carbonation medium can be via an auger. After the addition of carbonation medium and/or water to the tray, the tray and the carbonation medium can be inspected. The tray can then be accepted and advanced in the process or rejected for recycling or further processing.

Step 16 includes transporting the tray with the carbonation medium to a second caddy at the unloading dock. In some embodiments, the second caddy can a different caddy from the first caddy. In some embodiments, the second caddy can be the same caddy as the first caddy. In some embodiments, the loading dock can be part of the same structure as the unloading dock. In some embodiments, the loading dock and the unloading dock can be in separate structures.

Step 17 is optional and includes monitoring the amount of carbonation medium in a tray. In some embodiments, determination of the amount of carbonation medium in a tray can be via weighting the tray. The tray can be weight at a weigh station. In some embodiments, the weigh station can be disposed on a caddy. In some embodiments, the weigh station can be disposed on a tray mover, such that the weight can be determined while the tray is in motion. In some embodiments, the amount of carbonation medium in a tray can be monitored via a visual inspection tool. In some embodiments, the visual inspection tool can be used to measure the fill level and/or the fill uniformity of the carbonation medium in the tray.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described.

Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1-34. (canceled)

35. A tray processing unit (TPU), comprising:
a loading dock configured to receive a caddy including trays disposed thereon;
a collection station configured to receive trays from the loading dock and collect a carbonated medium from the trays;
a filling station configured to transfer a carbonation medium to the trays;
a first tray mover configured to transport the trays from the caddy at the loading dock to the collection station;
an unloading dock configured to support the caddy while loading the caddy with trays;
a second tray mover configured to transport trays from the collection station to the filling station; and
a third tray mover configured to transport trays from the filling station to the caddy supported by the unloading dock.

36. The TPU of claim 35, further comprising:
an unloader configured to transport trays from the loading dock to the collection station, the unloader configured to move vertically to select a vertical placement position of the trays in the caddy.

37. The TPU of claim 36, further comprising:
a loader configured to transport trays from the second tray mover to the caddy at the unloading dock.

38. The TPU of claim 35, further comprising:
a first vehicle configured to transport the caddy between the unloading dock and a carbonation contactor.

39. The TPU of claim 35, wherein the collection station includes a tray enclosure and a trough, the tray enclosure configured to manipulate the trays, such that the carbonated medium falls from the tray to the trough.

40. The TPU of claim 39, wherein manipulating the trays includes at least one of rotating, applying a vacuum, vibrating, stirring, or applying ultrasonic waves to the trays.

41. The TPU of claim 39, further comprising:
a silo in communication with the trough;
a conveyor configured to transport carbonated medium from the trough to the silo; and
a vacuum configured to reduce pressure inside the silo and draw carbonated medium into the silo.

42. The TPU of claim 41, wherein the conveyor includes an auger.

43. The TPU of claim 41, wherein the conveyor includes a pneumatic conveyor.

44. The TPU of claim 35, wherein the filling station includes a spraying apparatus configured to wet the carbonation medium.

45. The TPU of claim 35, wherein the first tray mover and the second tray mover include actuated end effector pins configured to move the trays.

46. The TPU of claim 35, wherein the unloading dock includes a roller configured to transfer the caddy from the unloading dock to a vehicle.

47. The TPU of claim 38, wherein the first vehicle includes a lifter module configured to dock and undock caddies to the loading dock and from the unloading dock.

48. The TPU of claim 47, wherein the unloading dock includes a locating pin configured to actuate to lock the caddy in place.

49. The TPU of claim 35, further comprising:
a weigh station configured to weigh the trays.

50. The TPU of claim 35, further comprising:
an inspection tool configured to measure an amount of at least one of carbonation medium or carbonated medium in a tray.

51. A method, comprising:
loading a first caddy onto a loading dock, the first caddy including a tray, the tray including a carbonated medium;
transporting the tray from the first caddy at the loading dock to a collection station;
at the collection station, at least partially removing the carbonated medium from the tray;
transporting the tray from the collection station to a filling station;
at the filling station, at least partially filling the tray with a carbonation medium; and
transporting the tray with the carbonation medium to a second caddy at an unloading dock.

52. The method of claim 51, wherein the tray is selected based on the carbonation extent of the carbonated medium included therein.

53. The method of claim 51, further comprising:
transporting the second caddy from the unloading dock to a carbonation contactor via a vehicle.

54. The method of claim 51, further comprising:
transporting the first caddy from a carbonation contactor to the loading dock.

55. The method of claim 51, further comprising:
spraying water onto the carbonation medium at the filling station and/or after the tray has exited the filling station.

56. The method of claim 51, further comprising:
vertically translating the tray to place the tray in the second caddy.
